(19) United States
(12) Patent Application Publication
(10) Pub. No.: US 2009/0199232 A1
(43) Pub. Date: Aug. 6, 2009

(54) RECORDING AND PLAYING SYSTEM, CLIENT TERMINAL AND SERVER TERMINAL

(75) Inventors: Shinji TAKEYAMA, Hiroshima (JP); Naohisa MOTOMURA, Hiroshima (JP); Satomi KODAMA, Hiroshima (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/362,798

(22) Filed: Jan. 30, 2009

Related U.S. Application Data
(60) Provisional application No. 61/025,073, filed on Jan. 31, 2008.

(51) Int. Cl. H04N 7/025; H04N 7/18; G08B 21/00

(52) U.S. Cl. 725/33; 725/82; 340/540

(57) ABSTRACT

Provided is a recording and playing system that prevents, even when a client terminal having no recording function receives emergency information, missing out on a program viewed with the client terminal. The system includes a server terminal and a client terminal connected to each other via a network. From among a plurality of broadcast contents, the server terminal receives a portion of a broadcast content that is broadcast after an instruction to perform recording is received. It transmits the portion to the client terminal as a recorded content. The client terminal detects start and finish of reception of the emergency information, and during the emergency information reception, notifies the user of the emergency information. When detected that the emergency information reception has started, the client terminal instructs the server terminal to perform recording, receives a recorded content from the server terminal through a request to the server terminal, and plays the recorded content in place of a broadcast content.

### BACKGROUND OF THE INVENTION

(1) Field of the Invention

The present invention relates a recording and playing system utilizing a home AV network and including a recording and playing apparatus (server terminal) and a playing apparatus (client terminal) where the recording and playing apparatus receives and records broadcast contents and the playing apparatus receives and plays recorded contents and so on transferred from the recording and playing apparatus. In particular, the present invention relates to a technique used for apparatuses connected via a network that provide users with a variety of recording and playing functions using devices of a different apparatus.

(2) Description of the Related Art

Broadcast waves transmitted from broadcast stations can contain not only video and audio, but also data, application programs (hereinafter simply referred to as application) and so on by superimposition on the broadcast waves. As for the superimposition of data on broadcast waves, broadcast receiving terminals are available which receive data for displaying a program guide, weather forecast and so on and execute a resident application preinstalled in each broadcast receiving terminal (i.e. resident application) so that a process such as display is performed using the received data. As for the superimposition of applications on broadcast waves and transmission of the resulting broadcast waves, Europe has laid down the Digital Video Broadcasting-Multimedia Home Platform (DVB-MHP) specification, and it has become possible to use applications created by broadcasting companies as operational user interfaces of broadcast receiving terminals. The United States has laid down the OpenCable Application Platform (OCAP) specification (Non-Patent Reference 1) based on the DVB-MHP specification. It provides similar functions in the cable broadcast environment, and the operation thereof has commenced. In these specifications, the applications superimposed on broadcast waves are written in the Java™ language.

The broadcast receiving terminals are provided with various Application Program Interfaces (APIs) for turning, graphics display, and playing of video. The applications superimposed on the broadcast waves call these APIs to control such functions and lo display contents to users, for example.

Furthermore, North America has laid down the OCAP Digital Video Recording (DVR) Extension specification (Non-Patent Reference 2) which is the OCAP specification added with a recording and playing function. The broadcast receiving terminals compatible with the OCAP DVR specification are capable of recording broadcast contents on a recording medium such as a hard disk which allows high speed random access. Moreover, as for the playing of recorded contents, the broadcast receiving terminals implement trick-play functions for playing contents at a given speed and functions for playing contents from a given position, such as fast-forwarding, fast-rewinding, slowing down, pause, and skip, and so on. The broadcast receiving terminals compatible with the OCAP DVR specification allow a Java application loaded into the broadcast receiving terminals from broadcast waves to utilize the functions of content recording and trick-play. More specifically, the broadcast receiving terminals compatible with the OCAP DVR specification are provided with an API for content recording and trick-play. The Java application loaded from broadcast waves calls the API to control each function so that a display for the playing of the recorded contents is presented to the users.

At present, while the broadcast receiving terminals having a recording and playing function are widely spread, the improvement of the broadband environment has popularized Internet access from households. Along with this, amid the growing proliferation of a home network environment that allows rooms in a house to be connected via an IP network, there has been increasing demand to seamlessly use contents recorded in a broadcast receiving terminal with another terminal connected to the broadcast receiving terminal via a home network.

To be more specific, a home network connects a server terminal (a recording and playing apparatus) which is a broadcast lo receiving terminal placed in the living room and equipped with a recording function with a client terminal (a playing apparatus such as TV) which is placed in a bedroom and not equipped with a recording function. A home AV network environment having such a server terminal and a client terminal allows the user in the bedroom to view, using the client terminal, contents recorded into the server terminal placed in the living room. Such a system is defined by the Digital Living Network Alliance (DLNA) specification. With the DLNA, it is possible to use terminals connected via the network using the Universal Plug and Play (UPnP) specification, and contents recorded by such terminals can be used with different terminals.

To achieve such a home AV network environment, North America is currently in the process of laying down the OCAP Home Networking (HN) Extension specification (Non-Patent Reference 3). This specification defines the API dedicated for controlling recording and playing and capable of calling a Java application (may be an application downloaded via broadcast waves or a resident application). As described above, use of the functions of the home AV network environment enables some client terminals among a plurality of terminals connected to the network to perform processes with a server terminal, such as remote timer recording and streaming play (a process in which a server terminal transmits a recorded content to other terminals, i.e. client terminals, connected to the server terminal via the home network, and then the client terminals receive and play the recorded content). A recording and playing system in such a home AV network environment does not require a server terminal (recording and playing terminal) in each room, but only needs an advanced server terminal in one room such as a living room, and inexpensive client terminals in rooms such as bedrooms and children's rooms.

Further, a broadcast receiving terminal has conventionally been proposed which, upon receipt of emergency information (emergency broadcast), displays the emergency information in place of the program viewed thus far, and starts recording the program viewed thus far and starts playing the recorded program when the emergency information reception is finished (see Patent Reference 1, for example). It is to be noted that the emergency information refers to information displayed with a higher priority when received, compared to a currently viewed program.
[Patent Reference 1] Japanese Unexamined Patent Application Publication No. 2006-333490
[Non-Patent Reference 1] OCAP Specification OC-SP-OCAP 1.0-I16-050803
[Non-Patent Reference 2] OCAP-DVR Specification OC-SP-OCAP-DVR-I03-070509
[Non-Patent Reference 3] OCAP Home Network Extension Specification OC-SP-OCAP-HNEXT 1.0-I01-050519

However, there is still a problem of not being able to provide users with suitable services even when the broadcast receiving terminal of the above mentioned Patent Reference 1 is used as a server terminal in the home AV network environment (recording and playing system) which is to become mainstream in the future and is connected to a client terminal.

An example of the home AV network environment includes just one server terminal and plural client terminals in a household which are connected via a network. The server terminal serves as the broadcast receiving terminal equipped with an advanced recording function and each of the client terminals is placed in a room of the household to serve as a broadcast receiving terminal having no recording function. Therefore, even when display of emergency information received interrupts viewing of a program (content) viewed thus far, the program can be recorded by using the server terminal of Patent Reference 1 as the server terminal of such a home AV network environment as above, since the server terminal has a recording function as described above. Nonetheless, when the emergency information is received and the viewing of the program is thus interrupted, the client terminals in each room cannot record the program because they are not equipped with a recording function. As a result, the display of the emergency information causes the users, who have been viewing the program using the client terminals, to miss out on a part of the program (content) viewed thus far.

### SUMMARY OF THE INVENTION

The present invention has been conceived in view of the above described problem, and an object of the present invention is to provide a recording and playing system that prevents, even when a client terminal which is not equipped with a recording function receives emergency information, missing out on a program viewed with the client terminal.

In order to achieve the above object, the recording and playing system of the present invention is a recording and playing system comprising a server terminal and a client terminal connected to each other via a network, the server terminal including: a receiving and recording unit configured to, when an instruction to perform recording is received from the client terminal, receive a portion of a broadcast content among a plurality of broadcast contents that are broadcast and record the received portion, the received and recorded portion of the broadcast content being broadcast on a channel which is selected by the client terminal before the client terminal receives emergency information, and the received and recorded portion of the broadcast content being a portion broadcast on the selected channel after the instruction is received; and a recorded content transmitting unit configured to transmit, in response to a request from the client terminal to perform transmission, the portion of the broadcast content recorded by the receiving and recording unit to the client terminal as a recorded content, and the client terminal including: a broadcast content playing unit configured to receive the plurality of broadcast contents, select, from among the received broadcast contents, a broadcast content that is broadcast on a first channel, and play the selected broadcast content; an emergency information detecting unit configured to receive the emergency information that is broadcast on a second channel and detect start and finish of the reception of the emergency information; an emergency information notifying unit configured to, while the emergency information detecting unit receives the emergency information, interrupt the playing of the broadcast content on the first channel and notify a user of the client terminal of the received emergency information, the broadcast content on the first channel being selected before the emergency information detecting unit detects that the reception of the emergency information has started; a recording instructing unit configured to instruct the server terminal to record the broadcast content which is broadcast on the first channel after the emergency information detecting unit detects that the reception of the emergency information has started,, the instruction to the server terminal being issued when the emergency information detecting unit detects that the reception of the emergency information has started; and a recorded content playing unit configured to receive, from the server terminal, the recorded content which is the portion, recorded by the server terminal, of the broadcast content on the first channel, and to play the recorded content received, instead of the playing performed by the broadcast content playing unit, the recorded content being received from the server terminal by issuing the request to the server terminal for the recorded content, and the reception and playing of the recorded content being performed after the emergency information detecting unit detects that the reception of the emergency information has finished.

With this structure, when the client terminal detects that the emergency information reception has started, the server terminal is instructed to record, out of the broadcast content which has been the target to be played by the client terminal immediately prior to the emergency information reception, a portion that is broadcast after the emergency information reception starts. The portion recorded by the server terminal according to the instruction is transmitted to the client terminal as a recorded content after the notification of the emergency information is finished so that it is played by the client terminal. Therefore, even in the case where the display is switched to the emergency information while the broadcast content is viewed using a client terminal having no recording function and thus the viewing of the broadcast content becomes difficult, the originally viewed broadcast content is not missed out.

Further, it may be that the emergency information contains information concerning a notification method which is a method for notifying the emergency information, the client terminal further includes a notification method informing unit configured to identify the notification method contained in the emergency information and to inform the server terminal of the identified notification method, the notification method being a method for notifying the emergency information received by the emergency information detecting unit, the emergency information notifying unit of the client terminal is configured to, according to the notification method identified by the notification method informing unit, interrupt the playing of the broadcast content on the first channel and notify the user of the client terminal of the received emergency information, the broadcast content on the first channel being selected before the emergency information detecting unit detects that the reception of the emergency information has started, and the receiving and recording unit of the server terminal is further configured to judge, lo based on the notification method informed by the notification method informing unit, whether or not the broadcast content on the first channel should be recorded after the emergency information detecting unit of the client terminal detects that the reception of the emergency information has started, and to start recording the broadcast content on the first channel when the instruction to perform the recording is received from the client terminal and a result of the judgment shows that the recording should be performed.

With this structure, the recording (proxy recording) performed by the server terminal for the client terminal is carried out according to a method of notifying the emergency information. More specifically, when the notification according to the notification method significantly interrupts the client terminal from playing or viewing the currently broadcast content (broadcast content), the server terminal performs the proxy recording, whereas when the interruption is not significant, the server terminal does not perform the proxy recording. For example, in the case of employing a notification method in which an emergency information channel is forcibly selected, or a notification method in which the audio for the broadcast content is switched to the audio for the emergency information, the above mentioned playing or viewing is significantly interrupted, and thus the proxy recording is performed. On the other hand, in the case of employing a notification method in which emergency information text is displayed on the video of the broadcast content, the above mentioned playing or viewing is not significantly interrupted, and thus the proxy recording is not performed. As a result, when the playing or viewing is not significantly interrupted, the proxy recording is not performed, which makes it possible to reduce the process load of the server terminal, and thus the resources of the server terminal can be efficiently used.

Furthermore, it may be that the client terminal further includes a server registering unit configured to search for a server terminal which is connected to the network and is capable of receiving and recording a broadcast content, and to register the searched out server terminal as a destination of the instruction to record the broadcast content on the first channel, the playing of which is interrupted, the recording instructing unit is configured to instruct the server terminal registered by the server registering unit to record the broadcast content on the first channel, the playing of which is interrupted, and the recorded content playing unit is configured to request the server terminal registered by the server registering unit for the recorded content.

With this structure, a server terminal capable of receiving and recording a broadcast content is searched out and registered in advance. As a result, upon the detection that the emergency information reception has started, the client terminal can immediately instruct the registered server terminal to perform the proxy recording, and the recorded content can be speedily received.

Moreover, it may be that the client terminal further includes an alarming unit configured to alarm the user of the client terminal about absence of the server terminal when the server registering unit does not search out the server terminal which is connected to the network and is capable of receiving and recording a broadcast content.

With this structure, when a server terminal capable of performing the proxy recording is absent, the user is alarmed about the absence of the server terminal in advance, allowing the user to recognize the possibility of missing out on the broadcast content due to the absence of the server terminal capable of performing the proxy recording.

In addition, it may be that the client terminal further includes an alarming unit configured to alarm the user of the client terminal about absence of the server terminal when the server terminal registered by the server registering unit is detected as having disconnected from the network.

With this, the user of the client terminal can recognize more quickly that the registered server terminal can no longer perform the recording. As a result, it is possible to eliminate a situation where the user of the client terminal assumes that the server terminal is performing the recording although no recording is actually being performed. Moreover, after being alarmed about the absence, the user of the client terminal can cause a different server terminal to perform the proxy recording.

Moreover, it may be that the client terminal further includes a viewing information transmitting unit configured to transmit viewing information for identifying the broadcast content played by the broadcast content playing unit, and the receiving and recording unit of the server terminal is configured to identify, from among the plurality of broadcast contents, a broadcast content to be recorded, based on the viewing information transmitted from the viewing information transmitting unit.

With this structure, the client terminal transmits the viewing information to the server terminal, enabling the server terminal to easily identify, as a broadcast content to be recorded and a channel corresponding to the broadcast content to be recorded, the broadcast content currently played by the client terminal and a channel corresponding to the broadcast content viewed.

Further, it may be that the viewing information transmitting unit of the client terminal is configured to transmit the viewing information at a predetermined timing, and the server terminal further includes a terminal-specific viewing information managing unit configured to update terminal-specific viewing information by generating, every time the viewing information is received from the client terminal, terminal-specific viewing information that contains up-to-date viewing information, and to hold the updated terminal-specific viewing information.

With this structure, the terminal-specific viewing information can be kept up-to-date invariably, thereby enabling the server terminal to always appropriately identify the broadcast content to be recorded.

Moreover, it may be that the server terminal further includes a recording start information transmitting unit configured to transmit, to the client terminal, recording start information indicating that the receiving and recording unit has started the recording, and the client terminal further includes a recording start displaying unit configured to receive the recording start information and to display, in text, details of the recording start information. Alternatively, it may be that the server terminal further includes a recording termination information transmitting unit configured to transmit, to the client terminal, recording termination information indicating that the receiving and recording unit has terminated the recording, and the client terminal further includes a recording termination displaying unit configured to receive the recording termination information and to display, in text, details of the recording termination information.

With this structure, the start and termination of the recording performed by the server terminal are notified to the user of the client terminal, and thus the user interface can be improved.

Further, it may be that the recorded content playing unit of the client terminal is configured to request the server terminal for the recorded content when a user operation is received after the reception of the emergency information is detected as having finished, and to start playing the recorded content received through the request.

As a result, the user can view the recorded content at a desired timing.

Furthermore, it may be that the recorded content playing unit of the client terminal is configured to request the server terminal for the recorded content when the reception of the emergency information is detected as having finished, and to start playing the recorded content received through the request.

As a result, the user can view the recorded content immediately after the emergency information notification is finished.

In addition, in order to achieve the above object, the recording and playing system of the present invention is a recording and playing system comprising a server terminal and a client terminal connected to each other via a network, the server terminal including: an emergency information detecting unit configured to receive emergency information that is broadcast on a second channel and detect start and finish of the reception of the emergency information; a receiving and recording unit configured to receive a portion of a broadcast content among a plurality of broadcast contents that are broadcast, and to record the received portion, the received and recorded portion of the broadcast content being broadcast on a channel which is selected by the client terminal before the emergency information detecting unit detects that the reception of the emergency information has started, and the received and recorded portion of the broadcast content being a portion broadcast on the selected channel after the emergency information detecting unit detects that the reception of the emergency information has started; and a recorded content transmitting unit configured to transmit the portion of the broadcast content recorded by the receiving and recording unit to the client terminal as a recorded content after the emergency information detecting unit detects that the reception of the emergency information has finished, and the client terminal including: a broadcast content playing unit configured to receive the plurality of broadcast contents, select, from among the received broadcast contents, a broadcast content on a first channel, and play the selected broadcast content; an emergency information receiving unit configured to receive the emergency information that is broadcast on the second channel; an emergency information notifying unit configured to, while the emergency information receiving unit receives the emergency information, interrupt the playing of the broadcast content on the first channel and notify a user of the client terminal of the received emergency information, the broadcast content on the first channel being selected by the broadcast content playing unit before the reception of the emergency information; and a recorded content playing unit configured to receive, from the server terminal, the recorded content which is the recorded portion of the broadcast content, and to play the recorded content received, instead of the playing performed by the broadcast content playing unit.

With this structure, when the server terminal detects that the emergency information reception has started, the server terminal performs the proxy recording for the client terminal, and transmits the recorded content to the client terminal after the emergency information notification is finished so that the transmitted recorded content is played by the client terminal. Therefore, even in the case where the display is switched to the emergency information while the broadcast content is viewed using a client terminal having no recording function and thus the viewing of the broadcast content becomes difficult, the originally viewed broadcast content is not missed out.

It is to be noted that the present invention can be embodied not only as such a recording and playing system as above, but also as: a server terminal and a client terminal included in the recording and playing system; a process operation method for the system and each of the terminals; a program which causes each of the terminals to perform process operations; and a storing medium which stores the program.

The recording and playing system according to the present invention achieves an advantageous effect that even when a client terminal having no recording function receives emergency information, it is possible to prevent missing out on a program viewed with the client terminal.

### FURTHER INFORMATION ABOUT TECHNICAL BACKGROUND TO THIS APPLICATION

The disclosure of U.S. Patent Application No. 61/025073 filed on Jan. 31, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram of a recording and playing system configuring a home AV network environment according to Embodiment 1 of the present invention;

FIG. 2 is a block diagram showing a hardware configuration of a server terminal according to Embodiment 1 of the present invention;

FIG. 3 is a block diagram showing a hardware configuration of a client terminal according to Embodiment 1 of the present invention;

FIG. 4 is a block diagram showing a software module configuration of a program to run by a server terminal according to Embodiment 1 of the present invention;

FIG. 5 is a block diagram showing a configuration of a library of a server terminal according to Embodiment 1 of the present invention;

FIG. 6 is a diagram showing an example of terminal-specific viewing information managed by a server terminal according to Embodiment 1 of the present invention;

FIG. 7A is a diagram showing an example of a proxy recording table held by a recording manager according to Embodiment 1 of the present invention;

FIG. 7B is a table showing a meaning of information stored in proxy recording setting according to Embodiment 1 of the present invention;

FIG. 8A is a diagram showing an example of management information held by a recording manager according to Embodiment 1 of the present invention;

FIG. 8B is a diagram showing another example of management information held by a recording manager according to Embodiment 1 of the present invention;

FIG. 9 is a diagram showing an example of a configuration of a network control manager according to Embodiment 1 of the present invention;

FIG. 10 is a block diagram showing a software module configuration of a program to be run by a client terminal according to Embodiment 1 of the present invention;

FIG. 11 is a block diagram showing a configuration of a library of a client terminal according to Embodiment 1 of the present invention;

FIG. 12 is a block diagram showing a configuration of a network control manager of a client terminal according to Embodiment 1 of the present invention;

FIG. 13 is a flowchart showing a process operation related to viewing information of a client terminal according to Embodiment 1 of the present invention;

FIG. 14 is a flowchart showing a process performed for updating terminal-specific viewing information held by a terminal-specific viewing information managing unit, performed by a server terminal according to Embodiment 1 of the present invention;

FIG. 15 is a sequence diagram showing an example of a process for updating terminal-specific viewing information, performed between a client terminal and a server terminal according to Embodiment 1 of the present invention;

FIG. 16 is a sequence diagram showing another example of a process for updating terminal-specific viewing information, performed between a client terminal and a server terminal according to Embodiment 1 of the present invention;

FIG. 17 is a flowchart showing an example of operations of a server terminal performed when the emergency broadcast is received according to Embodiment 1 of the present invention;

FIG. 18 is a flowchart showing another example of operations of a server terminal performed when the emergency broadcast is received according to Embodiment 1 of the present invention;

FIG. 19 is a table for describing emergency levels of emergency information according to Embodiment 1 of the present invention;

FIG. 20 is a flowchart showing detailed process operations in Step S1601 in FIGS. 17 and 18 according to Embodiment 1 of the present invention;

FIG. 21 is a flowchart showing an example of a process for playing a recorded content, performed by a client terminal according to Embodiment 1 of the present invention;

FIG. 22 is a sequence diagram showing a process to start recording, performed by a client terminal and a server terminal according to Embodiment 1 of the present invention;

FIG. 23 is a sequence diagram showing a process to start playing a recorded content, performed by a client terminal and a server terminal according to Embodiment 1 of the present invention;

FIG. 24 is a diagram for describing a content played according to Embodiment 1 of the present invention;

FIG. 25 is a flowchart showing an example of a process for playing a recorded content, performed by a client terminal according to Embodiment 2 of the present invention;

FIG. 26 is a sequence diagram showing a process to start playing a recorded content, performed by a client terminal and a server terminal according to Embodiment 2 of the present invention;

FIG. 27 is a sequence diagram showing another example of a process to start playing a recorded content, performed by a client terminal and a server terminal according to Embodiment 2 of the present invention;

FIG. 28 is a sequence diagram showing a record starting process performed by a client terminal and a server terminal according to Embodiment 3 of the present invention;

FIG. 29 is a sequence diagram showing a process to start playing a recorded content, performed by a client terminal and a server terminal according to Embodiment 3 of the present invention;

FIG. 30 is a sequence diagram showing another example of a process to start playing a recorded content, performed by a client terminal and a server terminal according to Embodiment 3 of the present invention; and

FIG. 31 is a flowchart showing process operations performed by a client terminal according to Embodiment 3 of the present invention when it starts receiving emergency information.

### DESCRIPTION OF THE PREFERRED EMBODIMENT(S)

Hereinafter, embodiments of the present invention shall be described with reference to the drawings.

### Embodiment 1

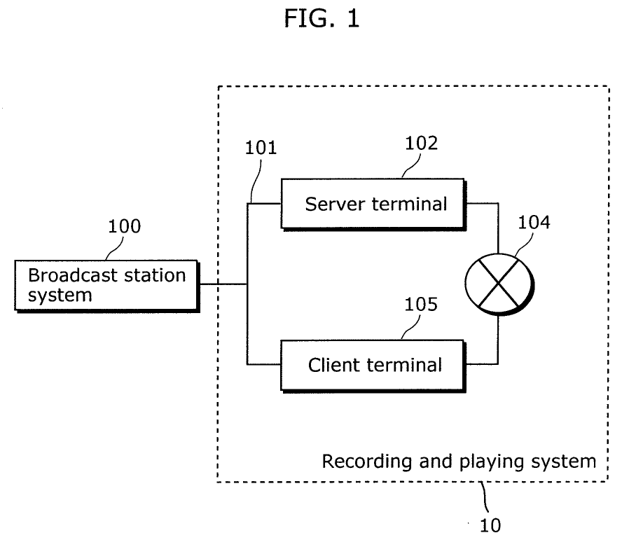

FIG. 1 is a block diagram of a recording and playing system configuring a home AV network environment according to an embodiment of the present invention.

As FIG. 1 shows, a recording and playing system 10 includes a server terminal apparatus (hereinafter referred to as a server terminal 102) 102, a client terminal apparatus (hereinafter referred to as a client terminal) 105, and a home network 104. Here, the server terminal 102 and the client terminal 105 are connected via a cable 101 to a broadcast station system 100 that transmits broadcast signals (broadcast waves).

In FIG. 1, the home network 104 is a home network established in a household, and is an IP network configured of the Ethernet™, wireless LAN, and so on. The server terminal 102 and the client terminal 105 are provided in the household, for example, and are capable of performing communication via the home network 104.

The broadcast station system 100 transmits modulated broadcast signals to terminal apparatuses including the server terminal 102 and the client terminal 105, and the server terminal 102 and the client terminal 105 receive the transmitted broadcast signals. The broadcast signals transmitted from the broadcast station system 100 to the server terminal 102 and the client terminal 105 include AV data containing video information, audio information and the like, and emergency information. It is to be noted that broadcasting the emergency information contained in the broadcast signals is referred to as emergency broadcast.

The frequency band used for the transmission between the broadcast station system 100 and the terminal apparatuses including the server terminal 102 and the client terminal 105 is divided. More specifically, the frequency band is broadly divided into two types, namely, Out Of Band (abbreviated as OOB) and In-Band. For example, the frequencies of 5 to 130 MHz are allocated to OOB, and are mainly used for data exchange between the broadcast station system 100 and the terminal apparatuses. The frequencies of 130 to 864 MHz are allocated to In-Band, and are divided into plural frequency bands so that each of the frequency bands is used for a broadcast channel containing video and/or audio. (For example, the frequencies of 150 to 156 MHz are allocated to a TV channel 1, the frequencies of 156 to 162 MHz to a TV channel 2, . . . , the frequencies of 310 to 311 MHz to a radio channel 1, and so on.) Each of these channels may be used for the analog broadcast or the digital broadcast. In the case of the digital broadcast, the transmission is carried out in the transport packet format in accordance with the MPEG-2 specification, and data for various data broadcast can be transmitted as well as audio and video. The emergency information may be contained in a channel allocated to In-Band or OOB.

Hereinafter, operations of the server terminal 102 and the client terminal 105 shall be described.

Upon connection with the home network 104, the server terminal 102 and the client terminal 105 each search for different apparatuses connected to the home network 104 and become aware of the functions of each of the different apparatuses. As with DLNA, this communication can be carried out by a method defined by the UPnP Device Architecture (DA), and thus a detailed description thereof shall be omitted. Through this communication, the server terminal 102 can recognize that the client terminal 105 is connected to the home network 104 and is a player that receives a recorded content via the home network 104 and plays the received content. Further, the client terminal 105 can recognize that the server terminal 102 is connected to the home network 104.

Hereinafter, communication carried out between the server terminal 102 and the client terminal 105 in relation to a content recorded into the server terminal 102 shall be described step by step.

First, the client terminal 105 issues a request to the server terminal 102 for a list of contents available to be provided by the server terminal 102. In response to the request, the server terminal 102 retrieves available contents and replies to the client terminal 105 with a list of the available contents.

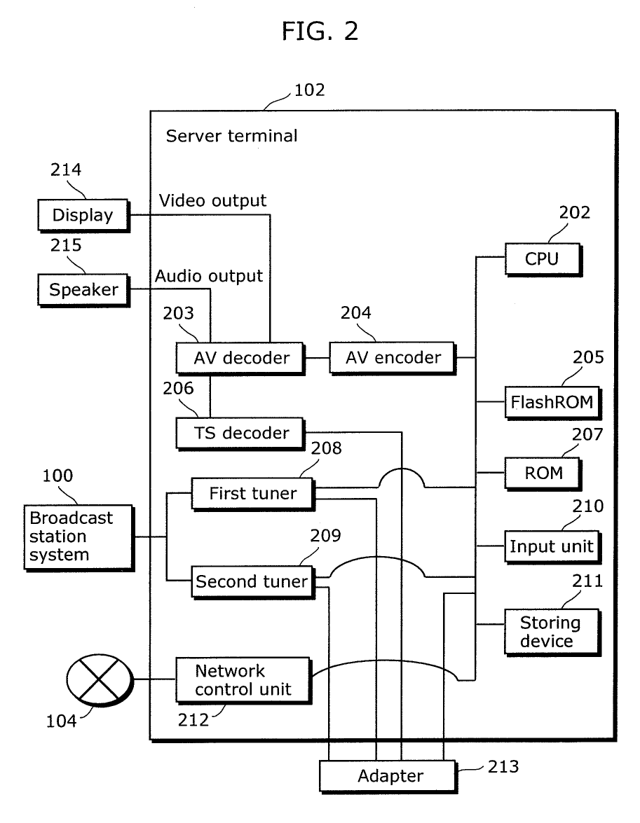

Upon the receipt of the available content list, the client terminal 105 presents the list to the user. Then, the client terminal 105 requests the server terminal 102 to transmit data corresponding to content selected by the user. The server terminal 102 reads the requested content from an after-mentioned storing device 211 (see FIG. 2), and transmits the content to the client terminal 105. The transmission of data corresponding to content employs, for example, HTTP which is a requisite protocol for DLNA. The details shall be provided later.

FIG. 2 is a block diagram showing an example of a hardware configuration of the server terminal 102 according to the present embodiment. The server terminal 102 shown in FIG. 2 includes, for example, a CPU 202, an AV decoder 203, an AV encoder 204, a Flash ROM 205, a TS decoder 206, a ROM 207, a first tuner 208, a second tuner 209, an input unit 210, a storing device 211, and a network control unit 212.

A display 214 in FIG. 2 is a device that receives video signals from a video output terminal (not shown) of the server terminal 102 and displays video information. Examples of the display 214 include a cathode-ray tube, a liquid crystal display and an organic Electro-Luminescence (EL) display.

A speaker 215 is a device that receives audio signals from an audio output terminal (not shown) of the server terminal 102 and outputs audio.

The storing device 211 is for storing a content contained in the broadcast signals transmitted from the broadcast station system 100, and is preferably a storing device having a large capacity, such as a Hard Disk Drive (HDD), for example.

The Flash ROM 205 is for storing, for example, data such as a program related to the content contained in the broadcast signals (a Java™ application program, for example) and information contained in program information (information such as Electronic Program Guide (EPG) or after-mentioned information such as Program Association Table (PAT), Program Map Table (PMT), and Application Information Table (AIT), for example). The Flash ROM 205 is preferably a RAM, for example, that allows reading/writing while not allowing stored data to be deleted at the time of power-off.

The application program related to the content may be contained in the broadcast signals broadcast by the broadcast station system 100 or downloaded via the Internet. The present embodiment shall be described supposing an example where the application program related to the content is contained in the broadcast signals broadcast by the broadcast station system 100.

The ROM 207 is for storing a program preinstalled at the time of, for example, shipment of the server terminal 102 (that is, a resident program) and allows reading only, not writing.

The CPU 202 runs programs stored on, for example, the ROM 207, the Flash ROM 205, or the storing device 211. According to instructions of the running programs, the CPU 202 controls the AV decoder 203, AV encoder 204, Flash ROM 205, TS decoder 206, ROM 207, first tuner 208, second tuner 209, input unit 210, storing device 211, and network control unit 212.

The first tuner 208 and the second tuner 209 are devices that demodulate the modulated broadcast signals transmitted from the broadcast station system 100, based on, for example, tuning information such as a frequency specified by the CPU 202.

It is to be noted that while FIG. 2 shows a dual-tuner model having the first tuner 208 and the second tuner 209, there may be three or more tuners or just one tuner.

The MPEG-2 transport streams, which can be obtained as a result of the demodulation performed by one or both of the first tuner 208 and the second tuner 209, are transmitted to the TS decoder 206 via an adapter 213 having a decryption function.

The adapter 213 is an apparatus that decrypts the MPEG-2 transport streams which have been encrypted and transmitted from the broadcast station system 100 with the In-Band frequency band. The adapter 213 has one or more descrambling devices, and is mounted detachably to the server terminal 102, for example. The adapter 213 also performs format conversion on data transmitted from the broadcast station system 100 with the Out-of-Band frequency band. The converted data can be used for programs running on the CPU 202.

The TS decoder 206 filters the MPEG-2 transport streams. Filtering is a process of extracting specific data contained in the MPEG-2 transport streams, and the details thereof are to be described later. The TS decoder 206 receives MPEG-2 transport streams from the adapter 213, for example, and filters the received MPEG-2 transport streams. The TS decoder 206 then outputs AV data extracted through the filtering to the AV decoder 203.

The MPEG-2 transport streams are composed of plural fixed-length (188 bytes, for example) TS packets. Each TS packet contains a header (4 bytes) that includes a packet ID, and a payload (184 bytes) which includes data to be transmitted (such as video, audio and emergency information). Combining payloads of the TS packets having the same packet ID enables reproduction of continuous video, audio, emergency information, and so on.

Now, formats of various data contained in the payloads shall be described. Video and audio are represented in a format called Packetized Elementary Stream (PES) packet. A PES packet contains video information or audio information of a particular time slot. By receiving a PES packet, the terminal apparatuses can output the video or audio information contained in the PES packet to a screen or a speaker. Through seamless transmission of the PES packets by the broadcast station, the terminal apparatuses can continue to play the video and audio seamlessly. At the time of actual transmission of a PES packet, in the case where the PES packet is larger in size than a payload of a single TS packet, it is divided to be stored in payloads of plural TS packets.

In contrast, information such as program scheduling information and data for data broadcast are represented in a format called MPEG-2 section. At the time of actual transmission of an MPEG-2 section, in the case where the MPEG-2 section is larger in size than a payload of a single TS packet, it is divided to be stored in payloads of plural TS packets.

The MPEG-2 section contains a header and a payload, for example. The header includes control information about the MPEG-2 section. The payload includes data to be transmitted in the MPEG-2 section. The control information about the MPEG-2 section included in the header contains, for example, information indicating the type of the MPEG-2 section and an extension identifier used for distinguishing between MPEG-2 sections of the same type.

When the payloads of TS packets identified with the same PID in an MPEG-2 transport stream are combined, they are called elementary streams (ES). More specifically, the ES for video information is called video ES and the ES for audio information is called audio ES.

The TS decoder 206 is a device having a function to sort out PES packets and MPEG-2 sections on the basis of a PID, a section filtering condition, and so on specified by the CPU 202. This sorting function is called packet filtering. The program scheduling information obtained from a payload of an MPEG-2 section is stored on the Flash ROM 205 to construct a database in the Flash ROM 205 lo containing program identifiers, tuning information, and so on.

After the filtering, the output of the TS decoder 206 is PES packets.

The AV decoder 203 is a device having a function to decode encoded video ES and audio ES. For example, the AV decoder 203 is takes out an encoded ES (such as a video ES and an audio ES) from a PES packet provided from the TS decoder 206, and decodes the encoded ES to generate and output a video signal and an audio signal. At the time of playing, the video signal is outputted from the display 214 via a video output terminal (not shown) and the audio signal is outputted from the speaker via an audio output terminal (not shown).

At the time of recording, the video signal and audio signal generated and outputted by the AV decoder 203 are outputted as MPEG-2 transport streams which are encoded by the AV encoder 204. Then the outputted signals are recorded into the storing device 211. Apart from this recording method, there is also a method of recording information supplied from the TS decoder 206 into the storing device 211.

The CPU 202 runs programs stored on the ROM 207. The CPU 202 can also run programs downloaded via broadcast signals or a network and stored on the Flash ROM 205 or in the storing device 211. According to the instructions of the running programs, the CPU 202 controls the first tuner 208, second tuner 209, TS decoder 206, AV decoder 203, network control unit 212, and so on.

The CPU 202 can control not only the devices of the server terminal 102 but also the adapter 213 through communication therewith.

The input unit 210 includes a front panel or a remote control receiving unit (not shown) and receives input from the user (selection of a channel or a recorded content, for example).

The network control unit 212 is a device having a function to send and receive any given data to and from a network, and performs communication by using the TCP/IP protocol. For example, in the present embodiment, the network control unit 212 receives an HTTP request in the TCP/IP packet format, and sends, as an HTTP response, a result obtained from a process performed by a program according to the request.

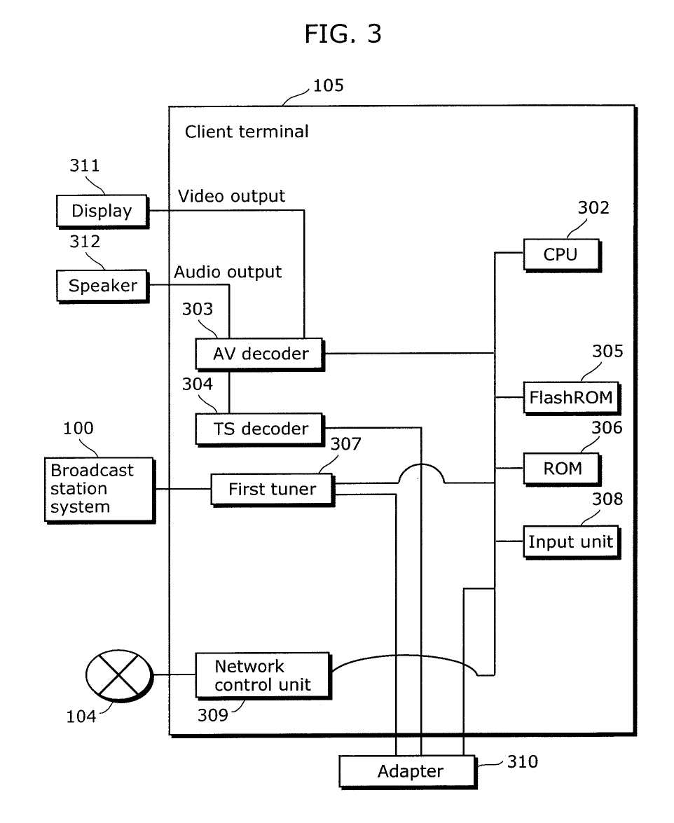

FIG. 3 is a block diagram showing an example of a detailed configuration of the client terminal 105.

The client terminal 105 has a configuration similar to that of the server terminal 102, yet is different from the server terminal 102 mainly in that a storing device and an AV encoder necessary for recording are not included and that there is only one tuner.

It should be noted that the structural elements in FIG. 3 with different reference numerals yet the same names compared to that in FIG. 2 are identical or equivalent to the above described elements, and thus detailed descriptions thereof shall be omitted here.

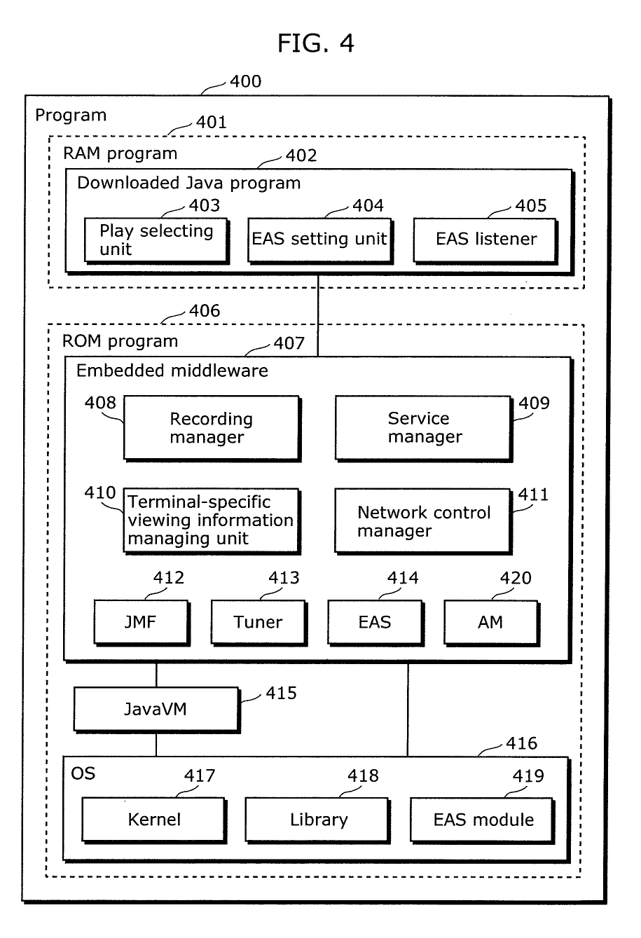

FIG. 4 is a diagram for describing an exemplary configuration of a program stored on the ROM 207 or Flash ROM 205 and run on the CPU 202 in the server terminal 102 shown in FIG. 2.

The program stored on the ROM 207 allows reading only (hereinafter referred to as a ROM program 406), while the program stored on the Flash ROM 205 allows reading and writing (hereinafter referred to as a RAM program 401). Although FIG. 4 shows an example where a downloaded Java program is stored on the Flash ROM 205, the present invention is not necessarily limited to this, and the program may be stored in the storing device 211, for example.

A program 400 is run on the CPU 202, and includes a ROM program 406 stored on the ROM 207 and a RAM program 401 stored on the Flash ROM 205.

Further, the ROM program 406 is a resident program stored in the server terminal 102 since the shipment of the server terminal 102, for example, and includes an OS 416, a Java VM 415, and embedded middleware 407. The RAM program 401 includes a downloaded Java program 402 or the like extracted from a broadcast signal (encrypted MPEG-2 transport stream), for example.

The OS 416 is an Operating System, and an example thereof is embedded Linux.

The OS 416 is a subprogram activated by the CPU 202 when the server terminal 102 is powered on. The OS 416 includes a kernel 417 (a program providing basic OS (Operating System) functions) which is high in abstractness, a library 418 and an EAS module 419, for example. In the present embodiment, the kernel 417 runs, for example, an after-mentioned Java VM 415 as a subprogram.

The library 418 includes Application Program Interfaces (APIs) each having a function to control a structural element of the hardware provided in the server terminal 102.

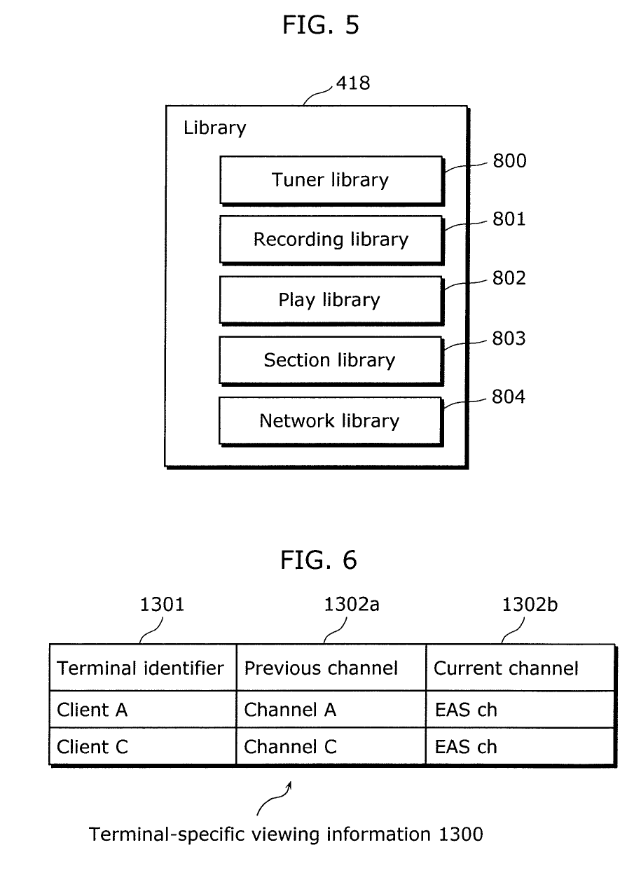

FIG. 5 is a diagram showing a configuration of the library 418.

In the present embodiment, as FIG. 5 shows, the library 418 includes a tuner library 800, a recording library 801, a play library 802, a section library 803 and a network library 804, for example.

The tuner library 800 has a function to cause a tuner to perform tuning with a specified frequency. Upon receipt of tuning information and information on a tuner to be controlled (tuner identifier) from an after-mentioned tuner 413, the tuner library 800 controls the tuning performed by the tuner associated with the received tuner identifier, which is either the first tuner 208 or the second tuner 209 of the server terminal 102.

The recording library 801 has a function to receive recording request information from a recording manager 408 and to record MPEG-2 transport streams outputted from a specified tuner at a specified location of the storing device 211. Here, if necessary, a java application related to a content may be extracted from the MPEG-2 transport streams and stored on the Flash ROM 205.

As a method for recording a content, the recording manager 408 can specify a content recording method and a time-shift recording method. Here, the content recording method requires explicit deletion of a content and the time-shift recording method is for recording a content only for a time period corresponding to a specified duration (or a specified time) and deleting the least recently recorded portion so as to record the excess portion.

The play library 802 has a function to control the storing device 211 and the AV decoder 203 so that either the MPEG-2 transport streams outputted from the specified tuner or the MPEG-2 transport streams recorded in the storing device 211 are played at a specified speed. The play library 802 receives from a service manager 409 information about the specified tuner or information identifying the content recorded in the storing device 211 and a speed at which the content is to be played.

It is to be noted that the process performed by the recording library 801 for recording the content in the storing device 211 can be carried out concurrently with the process of the play library 802 for playing the already-recorded portion in the storing device 211 out of the content currently being recorded. This concurrent process enables catch-up playing which is to play, while recording a program, a portion of the program that has already been recorded.

The section library 803 has a function to, for example, transmit a specified ID (a packet ID or an ID identifying a section type, for example) to the TS decoder 206, receive data generated and outputted as a result of the filtering process performed by the TS decoder 206, and then output the received data to another program that needs it.

The network library 804 has a function to take out an IP packet and archive the IP packet according to the TCP/IP protocol specification to take out a TCP packet. The network library 804 further has a function to archive the TCP packet according to the HTTP protocol specification to take out an HTTP message. In addition, the network library 804 has a function to IP-packetize messages according to the HTTP/TCP/IP protocol.

The EAS module 419 has a function to analyze details of the emergency information contained in the broadcast signals transmitted by the broadcast station system 100. The EAS module 419 passes on a packet ID corresponding to the emergency information to the section library 803. The section library 803 transmits the packet ID corresponding to the emergency information to the TS decoder 206, and feeds data generated and outputted through the filtering process of the TS decoder 206 to the EAS module 419 as the emergency information. This allows the EAS module 419 to receive the emergency information sorted out by the section library 803. For example, supposing that the EAS module 419 has passed on an ID for the emergency information to the section library 803, the section library 803 can transmit a packet ID corresponding to the emergency information to the TS decoder 206 and pass on the data generated and outputted through the filtering process of the TS decoder 206 to the EAS module 419 as data of the emergency information. Methods for notifying the emergency information include: a method of superimposing text (character information, for example) on a currently viewed screen and displaying the screen with the superimposed text; a method of switching the current audio output to an audio output for the emergency information while superimposing text on a currently viewed screen and displaying the resulting screen; and a method of forcibly selecting a channel for the emergency information to switch the currently viewed program to an emergency information program so that the emergency information program is viewed.

The EAS module 419 analyzes the emergency information provided from the section library 803 to determine whether or not a channel selection is necessary. The emergency information contains control information indicating: whether the emergency information should be displayed in text and be superimposed on the currently viewed screen so that the screen with the superimposed text will be displayed; whether the audio should be switched to the emergency information audio; or whether a forcible channel selection should be carried out. Based on the control information, the EAS module 419 determines whether or not a channel selection is necessary. In the case where the emergency information contains control information indicating that the forcible channel selection should be carried out, the control information contains information associated with a channel which should be selected by the forcible channel selection. In the case of determining that the forcible channel selection is necessary, the EAS module 419 notifies an EAS 414 that the forcible channel selection is necessary.

Here, the EAS 414 transmits to the recording manager 408 and the service manager 409 the emergency information received from the EAS module 419 and information regarding start and end of the forcible channel selection determined as necessary based on the emergency information. Further, in the case where an after-mentioned EAS listener 405 is registered, the EAS 414 also notifies the downloaded lava program of the emergency information received from the EAS module 419 and the information regarding start and end of the forcible channel selection determined as necessary based on the emergency information.

Upon the receipt of the notification from the EAS module 419 that the forcible channel selection is necessary, the EAS 414 notifies the recording manager 408 and the service manager 409 that the forcible channel selection is necessary. The service manager 409 carries out the forcible channel selection as necessary. In order to check the information (content such as a program) viewed using the client terminal 105 connected via the home network 104, the recording manager 408 refers to terminal-specific viewing information held by a terminal-specific viewing information managing unit 410.

FIG. 6 is a diagram showing the terminal-specific viewing information held by the terminal-specific viewing information managing unit 410.

The terminal-specific viewing information managing unit 410 holds terminal-specific viewing information 1300 as shown in FIG. 6, for example. In FIG. 6, the terminal-specific viewing information 1300 shows a terminal identifier 1301, and a previous channel 1302a and a current channel 1302b in association with one another. The terminal identifier 1301 indicates an identifier for identifying a client terminal connected to the server terminal 102 via the home network 104. The current channel 1302b indicates a channel currently tuned to by a first tuner equipped in a client terminal associated with a terminal identifier. The previous channel 1302a indicates a channel which had been tuned to immediately before the currently tuned channel (that is, a channel viewed prior to the forcible selection of the emergency information channel).

For example, as FIG. 6 shows, the terminal-specific viewing information 1300 shows that the channel currently tuned to by a client terminal associated with the terminal identifier 1301 “Client A”, that is, the current channel 1302b of the client terminal having the terminal identifier 1301 “Client A”, is an emergency information channel “EAS ch”. The terminal-specific viewing information 1300 further shows that “Channel A” is the previous channel 1302a which had been tuned to by the client terminal associated with the terminal identifier 1301 “Client A” immediately before the current channel 1302b.

The recording manager 408 refers to the terminal-specific viewing information 1300 held by the terminal-specific viewing information managing unit 410 to check whether or not the emergency information channel is selected as the channel currently tuned to by the tuner of the client terminal. In the case where the emergency information channel is selected, the recording manager 408 determines whether or not to perform proxy recording for the content corresponding to the previous channel which had been tuned to before the selection of the emergency information channel. In the case where a channel other than the emergency information channel is indicated in the terminal-specific viewing information 1300 as the current channel 1302b associated with the terminal identifier of the client terminal 105 at the time when the server terminal 102 starts receiving the emergency information, the recording manager 408 may determine to perform the proxy recording for the content corresponding to the current channel 1302b before the current channel 1302b is switched to the emergency information channel, for example.

It is to be noted that the proxy recording is recording performed by the server terminal 102 for a client terminal interrupted from playing or viewing a program (content) due to the emergency information.

Further, the terminal-specific viewing information managing unit 410 may refer to the terminal-specific viewing information 1300 based on the emergency information received by the server terminal 102 so as to start recording the program currently viewed by the client terminal 105. In that case, the terminal-specific viewing information managing unit 410 may determine to continue with the proxy recording in the case where checking, after a certain time period, the terminal-specific viewing information 1300 updated through a notification from the client terminal 105 shows that the client terminal 105 is set to the emergency information channel. On the other hand, the terminal-specific viewing information managing unit 410 may determine to terminate the continuation of the proxy recording in the case where the above check does not show that the client terminal 105 is set to the emergency information channel.

This further reduces the time period between the switch to the emergency information channel in the client terminal 105 and the start of the proxy recording by the server terminal 102, thereby making it possible to further approximate the time point of starting the proxy recording of the content to the time point of switching to the emergency information display.

This means that it is possible to reduce the amount of information that cannot be recorded due to a time lag between the switch to the emergency information display and the start of the proxy recording. As a result, the user of the client terminal 105 becomes able, when viewing the content recoded by the proxy recording, to view the content from a time point closer to the time point of switching to the emergency information display.

The content for which the proxy recording did not complete may be deleted at any of the following timings: the point at which the proxy recording was stopped; when there is no request for the content recorded by the proxy recording from the client terminal 105 for a certain time period; and the point of receiving a request from the user to delete the content.

This enables suppression of unnecessary content being stored in the storing device 211.

The recording manager 408 holds information concerning whether or not to perform the proxy recording (hereinafter referred to as a proxy recording table).

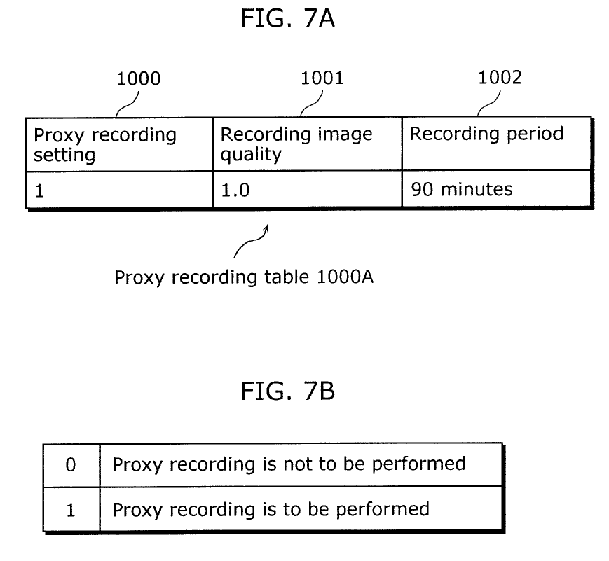

FIG. 7A is a diagram showing an example of the proxy recording table held by the recording manager 408.

A proxy recording table 1000A shows proxy recording setting 1000, a recording image quality 1001 and a recording period 1002. The proxy recording setting 1000 is information indicating whether or not to perform the proxy recording, and the recording image quality 1001 is information indicating an image quality when the proxy recording is performed (such as a compression rate and a bit rate). For example, the recording image quality 1001 shown in FIG. 7A indicates a compression rate of “1.0”. The recording period 1002 is information indicating a time period for which time-shift recording is to be performed. The proxy recording table 1000A shown in FIG. 7A is set by an after-mentioned EAS setting unit 404, for example.

FIG. 7B is a table showing the meaning of information stored in the proxy recording setting 1000.

In this table, “0” indicates that the proxy recording is not to be performed and “1” indicates that the proxy recording is to be performed.

The recording manager 408 refers to the table shown in FIG. 7B, and when the proxy recording setting 1000 indicates “1”, the recording manager 408 determines to perform the proxy recording, whereas when the proxy recording setting 1000 indicates “0”, it determines not to perform the proxy recording.

In the case of determining to perform the proxy recording, the recording manager 408 performs a process for securing resources of the server terminal 102. Here, the recording manager 408 holds management information.

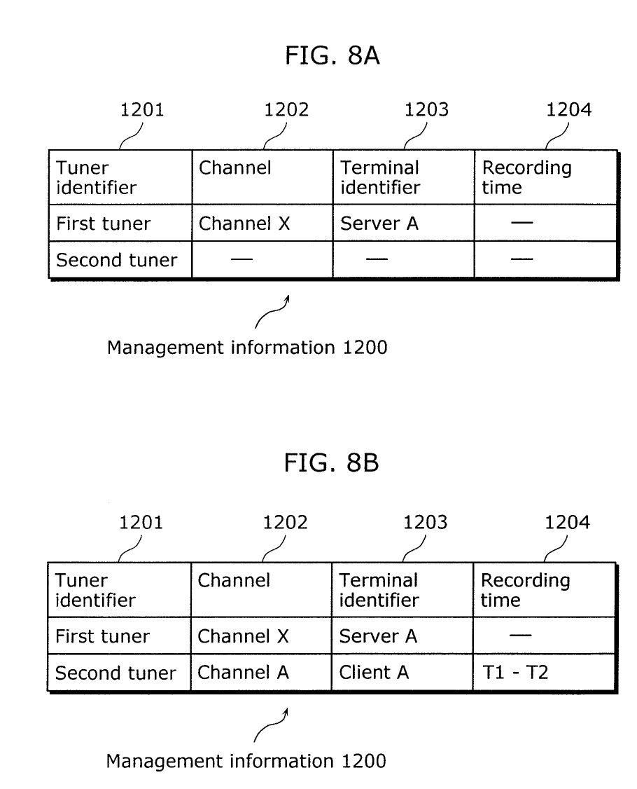

FIGS. 8A and 8B are diagrams showing an example of the management information held by the recording manager 408.

Management information 1200 is a table showing the status of use of resources necessary for the recording (the first tuner 208 and the second tuner 209 in this example) among the resources that the server terminal 102, for example, is provided with. It is to be noted that FIG. 8A shows the management information 1200 before the proxy recording is performed, and FIG. 8B shows the management information 1200 after the proxy recording is performed.

The management information 1200 contains a tuner identifier 1201 which is information for identifying a tuner equipped in the server terminal 102, a channel 1202 which is tuned to by a tuner associated with the tuner identifier 1201, a terminal identifier 1203 which is information indicating according to which terminal's request the recording is performed, and a recording time 1204 which is information indicating a time during which the recording is performed.

In the case of determining to perform the proxy recording, the recording manager 408 refers to the management information 1200 to secure the tuners of the server terminal 102. The details of the management information 1200 at this time are shown in FIG. 8A. In FIG. 8A, Channel X indicates a channel for displaying the emergency information, and a sign “−” indicates that there is no relevant information. The recording manager 408 judges that the first tuner cannot be used since it is selected for the channel for displaying the emergency information (Channel X) while the second tuner is available for the proxy recording since it is not used for the recording. As a result, the recording manager 408 issues a request to the recording library 801 that the proxy recording be performed through the time-shift recording using the second tuner for the recording period 1002 with the recording image quality 1001 shown in FIG. 7A.

In response to the request from the recording manager 408 to perform the proxy recording, the recording library 801 records the MPEG-2 transport streams outputted from the specified tuner (the second tuner in this example) at a specified location of the storing device 211.

The recording manager 408 updates the details of the management information 1200. As shown in FIG. 8B, the updated management information 1200 indicates the identifier of the client terminal 105 as the terminal identifier 1203 associated with the second tuner, and a channel (Channel A) which had been tuned to prior to the client terminal 105 switching to the emergency broadcast channel is indicated as the channel associated with the second tuner. Further, the updated management information 1200 indicates a recording start time T1 and an intended recording end time T2 as the recording time 1204 associated with the second tuner. Here, assuming that the recording performed by the recording library 801 is the time-shift recording, the intended recording end time T2 is the time point at which the recording period 1002 elapses from the recording start time T1. It is to be noted that when the time-shift recording continues for a time period exceeding the recording period 1002, the recording start time T1 and the intended recording end time T2 of the recording time 1204 are dynamically updated.

The EAS module 419 analyzes the emergency information supplied from the section library 803, and in the case of determining that it is no longer necessary to display the emergency information, the EAS module 419 notifies the EAS 414 that the emergency broadcast is finished. In the case where the EAS 414 had caused the service manager 409 to perform a forcible channel selection, the EAS 414 may instruct the service manager 409 to select the channel which had been tuned to prior to the forcible channel selection.

Upon the receipt of the notification, the EAS 414 notifies the recording manager 408 that the emergency broadcast is finished. Upon the receipt of the notification, the recording manager 408 waits for a play request from the client terminal 105 for a certain time period. When no play request is received during the certain time period, the recording manager 408 determines that the continued recording is unnecessary, and thus issues a request to the recording library 801 to terminate the proxy recording. Upon the receipt of the request to terminate the proxy recording, the recording library 801 performs control so as to terminate the recording of the MPEG-2 transport streams outputted from the specified tuner (the second tuner in this example) at a specified location of the storing device 211. Then, the recording manager 408 updates the details of the management information 1200 held in itself. To be more specific, the recording manager 408 changes the channel 1202, terminal identifier 1203 and recording time 1204 associated with the tuner identifier 1201 “the second tuner” in such a manner that each of them becomes “−”.

Such a configuration as described above enables the proxy recording to be performed using the recording function of the server terminal 102 connected to the client terminal 105 via the home network 104, even when the emergency information prevents the playing or viewing of a broadcast content using the client terminal 105 having no recording function. As a result, after the emergency broadcast is finished, the client terminal 105 can obtain, via the home network 104, the content recorded by the proxy recording and play the content obtained. In other words, even in the case where the user of the client terminal 105 misses out on a part of the content due to the emergency information, the user can still view the missed out part.

Using the received program identifier and the database stored separately on the Flash ROM 205, the service manager 409 constructs tuning information necessary for a tuner to tune to a program associated with the received program identifier. Then, the service manager 409 conveys the tuning information to the tuner 413, tuner library 800 and first tuner 208 (or second tuner 209) to complete the tuning, and causes the display to display the program associated with the received program identifier via the adapter 213, TS decoder 206, and AV decoder 203.

The EAS setting unit 404 is a program for making settings for a process of a program performed at the time of the emergency information reception. To be more specific, the EAS setting unit 404 sets, for the EAS 414, the proxy recording setting 1000, the recording image quality 1001, and the recording period 1002 of the proxy recording table 1000A shown in FIG. 7A.

The EAS listener 405 is a program for a listener process to be registered in the embedded middleware 407 by the downloaded Java program 402. When the listener process is registered, the embedded middleware 407 calls the EAS listener 405 so that the embedded middleware 407 can notify, via the EAS 414, the downloaded Java program 402 of the start and finish of the emergency information and the details of the emergency information.

The Java VM 415 is a Java virtual machine that sequentially analyzes and runs programs written in the Java™ language. The programs written in the Java language are compiled into intermediate codes called byte codes that are independent of hardware. The Java VM 415 sequentially analyzes and runs the intermediate codes. Such a configuration is a beneficial mechanism in such an operation as where, for example, various manufacturing companies manufacture the embedded middleware 407 and embedded middleware 507 (see FIG. 10) which are to be embedded into the server terminal 102 and the client terminal 105, respectively and the terminals run the same downloaded Java program 402 transmitted from the broadcast station system 100. The embedded middleware 407 is a program that downloads and runs the downloaded Java program 402. The embedded middleware 407 provides the downloaded Java program 402 with an API and so on for channel selection, and controls the library 418 and the hardware of the server terminal 102.

The service manager 409 manages a program identifier specified by the downloaded Java program 402 or the like and information related to the play function utilized by the embedded middleware 407. When a live broadcast is to be viewed, for example, the service manager 409 manages information such as a program identifier, tuning information, and a tuner identifier for identifying a tuner to be used (indicating which of the first tuner 208 and the second tuner 209 is to be used for the tuning). When a recorded content is to be played, the service manager 409 manages information indicating, for example, at which location of the storing device 211 the content to be played is stored.

The tuner 413 has a function to control either the first tuner 208 or the second tuner 209 via the tuner library 800. Upon the receipt of the information for identifying a tuner (a tuner identifier) and the tuning information from the service manager 409, for example, the tuner 413 passes the received tuner identifier and tuning information to the tuner library 800. Upon the receipt of the tuner identifier and the tuning information from the tuner 413, the tuner library 800 controls the tuning of the tuner associated with the received tuner identifier, which is either the first tuner 208 or the second tuner 209 of the server terminal 102.

A JMF 412 is a Java library that operates, for example, AV data corresponding to a program desired to be viewed. The JMF 412 is for obtaining, from a Program Association Table (PAT) and a Program Map Table (PMT) contained in broadcast signals, a packet ID for identifying video and audio to be played. The PAT is stored and transmitted in a packet having a packet ID “0”. To obtain the PAT, the JMF 412 specifies a packet ID “0” to the TS decoder 206 and obtains the PAT from the TS decoder 206 via the CPU 202.

The PAT specifies a packet ID of a PMT, and the JMF 412 identifies the PMT packet ID specified by the PAT and outputs the identified PMT packet ID to the section library 803. The section library 803 receives the result of filtering which the section library 803 causes the TS decoder 206 to perform based on the received PMT packet ID, and outputs the result to the JMF 412. As a result, the JMF 412 obtains the PMT.

The PMT specifies packet IDs of the video ES and audio ES to be played, and the IMF 412 identifies the packet IDs of the video ES and audio ES specified by the PMT and outputs the identified packet IDs to the TS decoder 206. The TS decoder 206 performs filtering using the packet IDs received from the IMF 412, and outputs the result of the filtering to the AV decoder 203.

An AM 420 has a function to extract a Java program contained in the MPEG-2 transport streams and to cause the Java VM 415 to run the extracted Java program. To embed the Java program in the MPEG-2 transport streams, a well-known, written scheme called Digital Storage Media-Command and Control (DSMCC) is used.

Here, a detailed description of the DSMCC shall be omitted. The DSMCC scheme defines in a packet of an MPEG-2 transport stream a method of encoding a file system composed of a directory and a file used in a computer.

Further, information on the Java program to be run is embedded and transmitted in a private section of a packet of the MPEG-2 transport stream in a format called Application Information Table (AIT). A packet ID of the AIT is specified by a PMT, and the AM 420 obtains a PAT and PMT in the same manner as that described in relation to the IMF 412. Thereafter, the AM 420 identifies the AIT packet ID specified by the PMT and outputs the identified packet ID to the section library 803. The section library 803 receives the result of filtering which the section library 803 causes the TS decoder 206 to perform based on the received AIT packet ID, and outputs the result to the AM 420. As a result, the AM 420 obtains the AIT. The AIT contains a DSMCC identifier necessary for extracting the packet ID containing the Java program to be run and control information for controlling the Java program to be run. The control information is, for example: control information indicating that the Java program loaded into the terminal is to be automatically run (autostart); control information indicating that the Java program is not to be automatically run (present); and control information indicating that the Java program is to be terminated (kill).

The AM 420 checks, based on the obtained AIT, whether or not the control information indicating that the Java program is to be automatically run (autostart) is contained, and in the case where it is contained, identifies a DSMCC identifier associated with the Java program.

In the case where there is a Java program containing the control information indicating that the Java program is to be automatically run (autostart), the PMT contains information for identifying the DSMCC identifier associated with this Java program and a packet ID associated with the contained information. The AM 420 finds from the PMT the above mentioned information for identifying the DSMCC identifier, identifies the associated packet ID, and outputs the identified packet ID to the section library 803.

The section library 803 receives the result of filtering which the section library 803 causes the TS decoder 206 to perform based on the received packet ID of an elementary stream associated with the DSMCC identifier, and outputs the result to the AM 420. The AM 420 extracts data on a file system and the like which can be obtained through reconstruction of the output provided from the section library 803 according to the DSMCC scheme, and stores the extracted data in a primary storing unit (not shown). The primary storing unit has a storing region in which necessary data is written and stored while the terminal (the server terminal 102) is powered on, and the stored data is deleted when the terminal is powered off.

Although the present embodiment illustrates an example where the file system extracted by the AM 420 is written and stored in the primary storing unit, the present invention is not limited to this. In the case of a repeatedly usable Java program, for example, the extracted file system may be stored on the Flash ROM 205, the storing device 211, or the like.

The AM 420 passes on, to the Java VM 415, a Java program to be run among programs in the file system stored in the primary storing unit, and the Java VM 415 interprets and runs the Java program received.

Use of the JMF 412, the AM 420 and the like enables concurrent execution of playing and outputting of AV data and running of the Java program.

A network control manager 411 has a function to respond to a message coming from outside the terminal (the server terminal 102) via a network (such as the home network 104 or the Internet).

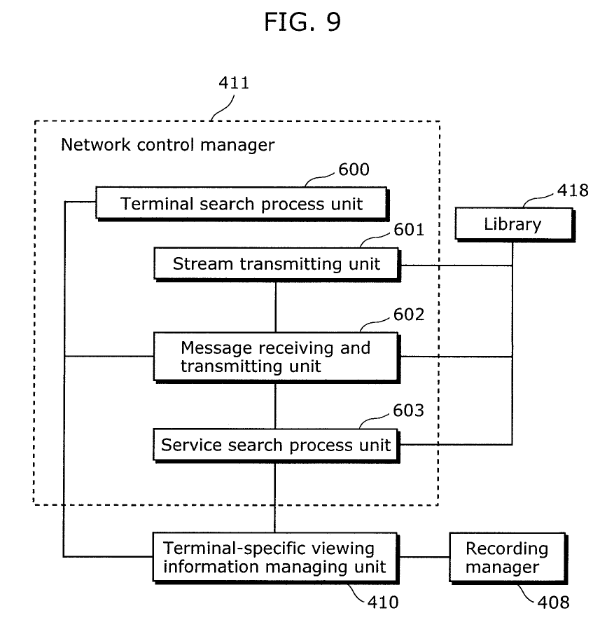

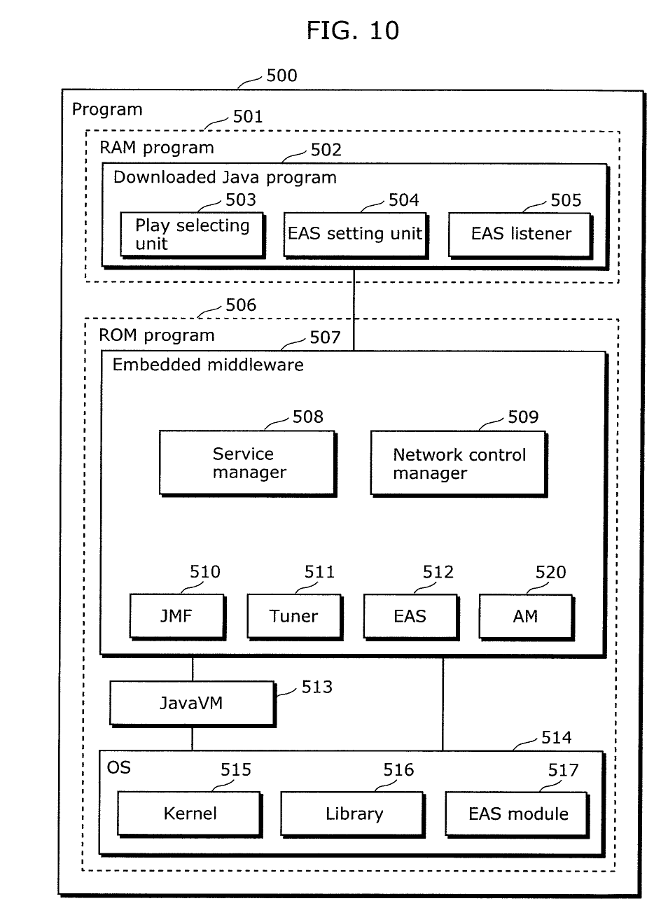

FIG. 9 is a diagram showing an example of the configuration of the network control manager 411.

The network control manager 411 includes, for example, a terminal search process unit 600, a service search process unit 603, a stream transmitting unit 601 and a message receiving and transmitting unit 602.

The message receiving and transmitting unit 602 receives a message coming from outside the terminal via a network, and according to the details of the message, issues a process request to the terminal search process unit 600, the service search process unit 603, and the stream transmitting unit 601. The network library 804 takes out an IP packet and archives the taken-out IP packet according to the TCP/IP protocol specification to take out a TCP packet. The network library 804 further archives the TCP packet according to the HTTP protocol specification to take out an HTTP message.

When the message receiving and transmitting unit 602 transmits a message, it inversely performs the above process, that is, it IP-packetizes a message according to the HTTP/TCP/IP protocol using the network library 804, and transmits the IP packet to a destination terminal.

In the present embodiment, the DLNA specification is used for communication between terminals via a network. The DLNA stands for Digital Living Network Alliance, and is a common specification used for reciprocal connection and control of home appliances via a network. The DLNA employs UPnP specification for checking appliances on the network and for obtaining services. The UPnP stands for Universal Plug and Play and is a common specification used for controlling terminals connected via a network. With the DLNA and UPnP, the HTTP protocol is employed for exchanging messages via a network. Then, commands defined by the DLNA and UPnP are transmitted and received in HTTP messages according to a specification. For more details, the DLNA specification and UPnP specification should be referred to.

In the present embodiment, a command contained in an HTTP message received by the message receiving and transmitting unit 602 indicates (1) a process request type and (2) an identifier of the terminal which has transmitted the message. The process request type may take any form as long as it is information that allows identification of a process request.

When transferring the command to a program that executes a process such as the process of the stream transmitting unit 601 and the service search process unit 603, the message receiving and transmitting unit 602 also passes on the above indication of a process request type and an identifier of the terminal which has transmitted the message. A process request here is a request for a process directly from the user of the server terminal 102, a request for a process from a Java program of the server terminal 102, or a request for a process such as playing, recording and/or streaming-transmission instructed from the user of a different terminal (the client terminal 105 in this example) or a Java program of the different terminal via the home network 104.

Process requests can be broadly classified as either: a process request issued directly from the user of the server terminal 102 or from a Java program of the server terminal 102 as described above; or a process request issued by another terminal via the home network 104. The process requests handled by the message receiving and transmitting unit 602 are process requests issued from another terminal via the home network 104.

The terminal search process unit 600 processes a terminal search command for searching for a recording terminal. In the case where archiving of the HTTP message received by the message receiving and transmitting unit 602 shows that the command contained in the HTTP message is a terminal search command, the message receiving and transmitting unit 602 transfers the terminal search command to the terminal search process unit 600.

For example, a terminal search command for searching for a recording terminal is transferred to the terminal search process unit 600. The terminal search process unit 600 judges whether or not the server terminal 102 having the terminal search process unit 600 has a recording function, and in the case where it has a recording function, generates a response command indicating that the terminal has a recording function, and sends the response command to the message receiving and transmitting unit 602. For example, the terminal search process unit 600 holds information indicating that the server terminal 102 having the terminal search process unit 600 has a recording function, and judges, based on the information, whether or not the server terminal 102 having the terminal search process unit 600 has a recording function. Another way for the terminal search process unit 600 to judge whether or not the server terminal 102 having the terminal search process unit 600 has a recording function is, for example, to check whether or not the storing device 211 that stores recorded contents is included. The message receiving and transmitting unit 602 packs the response command into an HTTP message and IP-packetizes the HTTP message according to the HTTP/TCP/IP protocol so as to transmit the response command to a destination terminal, the terminal which has transmitted the terminal search command to the message receiving and transmitting unit 602.

The service search process unit 603 processes a recorded content obtainment command for finding out about a recorded content held by the server terminal 102 having the service search process unit 603. In the case where archiving of the HTTP message received by the message receiving and transmitting unit 602 shows that the command contained in the HTTP message is a recorded content obtainment command, the message receiving and transmitting unit 602 transfers the recorded content obtainment command to the service search process unit 603.

From among the libraries included in the library 418, the service search process unit 603 uses a library having a function to retrieve contents recorded in the storing device 211 and to output a list which is information about all the contents recorded in the server terminal 102 having the service search process unit 603. By using the library, the service search process unit 603 obtains the list and sends it to the message receiving and transmitting unit 602. In other words, when there are two contents recorded, the service search process unit 603 sends information about both of the recorded contents to the message receiving and transmitting unit 602. The message receiving and transmitting unit 602 packs the received list, which is the information about the recorded contents, into an HTTP message, and IP-packetizes the HTTP message according to the HTTP/TCP/IP protocol so as to transmit the list to a destination terminal, the terminal which has transmitted the recorded content obtainment command to the message receiving and transmitting unit 602.

The stream transmitting unit 601 has a function to obtain from the storing device 211 the recorded content requested by a different terminal, that is, a portion or all of the recorded MPEG-2 transport streams, and to transmit the obtained recorded content to the terminal which has made the request.

Therefore, in the case where the command contained in the received HTTP message is for obtaining a portion or all of the MPEG-2 transport streams corresponding to the recorded content, the message receiving and transmitting unit 602 transfers that command to the stream transmitting unit 601. For example, when the command packed in the HTTP message is a command to obtain a portion of the MPEG-2 transport streams corresponding to a recorded content, the command indicates an identifier associated with the recorded content and the initial and last byte positions of the portion desired. In the case of such a command, the message receiving and transmitting unit 602 transfers the command to the stream transmitting unit 601.

The stream transmitting unit 601 identifies, based on the identifier associated with the recorded content, a file of the MPEG-2 transport streams corresponding to the recorded content stored in the storing device 211. Using the library 418, the stream transmitting unit 601 obtains, from the identified file, TS packet data starting from the initial byte position to the last position specified by the command, and sends the obtained TS packet data to the message receiving and transmitting unit 602. Thereafter, the message receiving and transmitting unit 602 packs into an HTTP message the byte data that is a portion or all of the MPEG-2 transport streams contained in the TS packet data received from the stream transmitting unit 601. The message receiving and transmitting unit 602 then IP-packetizes the HTTP message according to the HTTP/TCP/IP protocol so as to transmit the byte data to a destination terminal, the terminal which has transmitted the command to the message receiving and transmitting unit 602.

The stream transmitting unit 601 further has a function to transmit, in response to a request from a terminal other than the server terminal 102 having the stream transmitting unit 601, a broadcast content received by a tuner of the server terminal 102 having the stream transmitting unit 601, a time-shift recorded content (content recorded by the time-shift recording through the proxy recording, for example), and a Video On Demand (VOD) content, to the terminal which has made the request.

Therefore, in the case where the command packed in the received HTTP message is a command for obtaining a broadcast content, a time-shift recorded content or a Video On Demand (VOD) content, the message receiving and transmitting unit 602 transfers that command to the stream transmitting unit 601.

As with the service manager 409, the stream transmitting unit 601 obtains MPEG-2 transport streams corresponding to the specified broadcast content, time-shift recorded content or Video On Demand (VOD) content from the broadcast waves. Then the message receiving and transmitting unit 602 packs the byte data of the MPEG-2 transport streams received from the stream transmitting unit 601 into an HTTP message so as to send the byte data to the terminal which has transmitted the command to the message receiving and transmitting unit 602.

The downloaded Java program 402 is a program extracted from the broadcast signals transmitted from the broadcast station system 100 and stored on the Flash ROM 205 (or in the storing device 211) (in other words, it is downloaded). In FIG. 4, the downloaded Java program 402 includes programs to mainly function as a play selecting unit 403, an EAS setting unit 404, and an EAS listener 405. Although a preferable example of the downloaded Java program 402 is a monitor application, it is not limited to this. The downloaded Java program 402 may be a program having various functions useful for the user.

The functions useful for the user include a function to display a program guide on the screen and allow the user to point at a program shown in the program guide and press a set button to execute channel selection or timer recording. The descriptions of the useful functions, however, shall be omitted here since they are unnecessary for describing the present embodiment.

The play selecting unit 403 is a program for selecting a content to be played according to an input from the user. For example, the play selecting unit 403 displays, on the display, a program guide showing broadcast programs and a list of recorded contents. When the play selecting unit 403 receives via the input unit 210 a selection and input of a program that the user wishes to view, it specifies a program identifier associated with the program selected from among the currently broadcast programs, and passes on the specified program identifier to the service manager 409.

The EAS setting unit 404 is a program for making settings for a process of a program performed at the time of the emergency information reception. To be more specific, the EAS setting unit 404 sets, for the EAS 414, the proxy recording setting 1000, recording image quality 1001, and recording period 1002 of the proxy recording table 1000A shown in FIG. 7A.

The EAS listener 405 is a program for a listener process to be registered in the embedded middleware 407 by the downloaded Java program 402. When the listener process is registered, the embedded middleware 407 can notify, via the EAS 414, the downloaded Java program 402 of the start and finish of the emergency information reception and the details of the information by calling the EAS listener 405.

FIG. 10 is a diagram showing an exemplary configuration of a program of the client terminal 105 stored on a ROM 306 or a Flash ROM 305 and run on a CPU 302. A description of a program stored on a RAM is separately provided from a description of a program stored on a ROM.

A program 500 is run on the CPU 302. The program 500 includes a ROM program 506 stored on the ROM 306 and a RAM program 501 stored on the Flash ROM 305. The ROM program 506 includes an OS 514, a Java VM 513, and embedded middleware 507. The embedded middleware 507 includes a service manager 508, a network control manager 509, a JMF 510, a tuner 511, an EAS 512 and an AM 520. The OS 514 includes a kernel 515, a library 516, and an EAS module 517.

The RAM program 501 includes a downloaded Java program 502.

The library 516 of the OS 514 includes APIs each having a function to control a structural element of the hardware held by the client terminal 105.

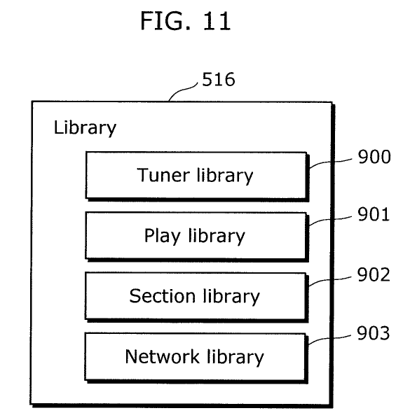

FIG. 11 is a diagram showing the configuration of the library 516.

As FIG. 11 shows, the library 516 includes a tuner library 900, a play library 901, a section library 902, a network library 903, and the like.

As apparent from comparison between the configuration of the program 400 of the server terminal 102 shown in FIG. 4 and that of the program 500 of the client terminal 105 shown in FIG. 10, the program 500 of the client terminal 105 does not include anything equivalent to the recording manager 408 and the terminal-specific viewing information managing unit 410 included in the program 400 of the server terminal 102. Further, as apparent from comparison between FIG. 5 and FIG. 11, the library 516 of the client terminal 105 does not include anything equivalent to the recording library 801 of the server terminal 102.

It should be noted that the structural elements in FIG. 10 with different reference numerals yet the same names compared to that in FIG. 4 are identical or equivalent to the elements described with reference to FIG. 4, and thus detailed descriptions thereof shall be omitted here. It should also be noted that the structural elements in FIG. 11 with different reference numerals yet the same names compared to that in FIG. 5 are identical or equivalent to the elements described with reference to FIG. 5, and thus detailed descriptions thereof shall be omitted here.

The downloaded Java program 502 is a program extracted from the broadcast signals of the broadcast station system 100 and stored on the Flash ROM 305 (in other words, it is downloaded). In FIG. 10, the downloaded Java program 502 includes programs to function mainly as a play selecting unit 503, an EAS setting unit 504, and an EAS listener 505. It is to be noted that the downloaded Java program 502 is not limited to this, and may be a program having various functions useful for the user.

The functions useful for the user include a function to display a program guide on the screen and allow the user to point at a program shown in the program guide and press a set button so that channel selection is executed or the server terminal 102 performs timer recording. The descriptions of the useful functions, however, shall be omitted here since they are unnecessary for describing the present embodiment.

The play selecting unit 503 selects a content to be played according to input from the user. For example, the play selecting unit 503 obtains a list of recorded contents held by the server terminal 102 via the network and displays the list on the screen so as to allow the user to specify a content he or she wishes to play.

The downloaded Java program 502 passes on information such as the identifier of the server terminal 102 and the identifier of the recorded content to the service manager 508.

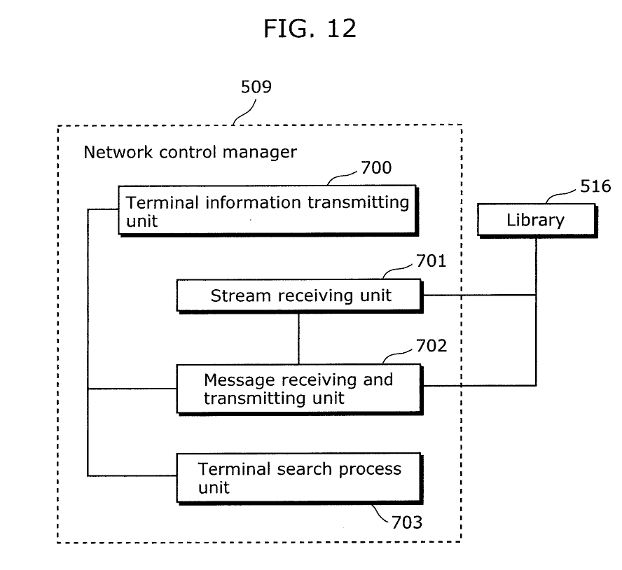

FIG. 12 is a diagram showing an example of a configuration of the network control manager 509.

The network control manager 509 includes a terminal information transmitting unit 700, a stream receiving unit 701, a message receiving and transmitting unit 702 and a terminal search process unit 703. After the service manager 508 requests the server terminal 102 via the home network 104 to perform a stream play via the home network 104, the stream receiving unit 701 receives MPEG-2 transport streams of a recorded content associated with the identifier passed on from the downloaded Java program 502, and transfers data associated with the received MPEG-2 transport streams to the play library 901 to cause the play library 901 to execute the play process using the transferred data. The terminal information transmitting unit 700 transmits the terminal information about the client terminal 105 itself (the terminal identifier of the client terminal 105) and currently-viewed-program information to the server terminal 102 via the message receiving and transmitting unit 702 every time the channel played is switched by the client terminal 105. It is to be noted that the currently-viewed program information is viewing information indicating the channel currently played by the client terminal 105 and viewed by the user.

Next, with reference to a flowchart, procedures of a process related to the recording and playing system 10 of the present embodiment shall be described.

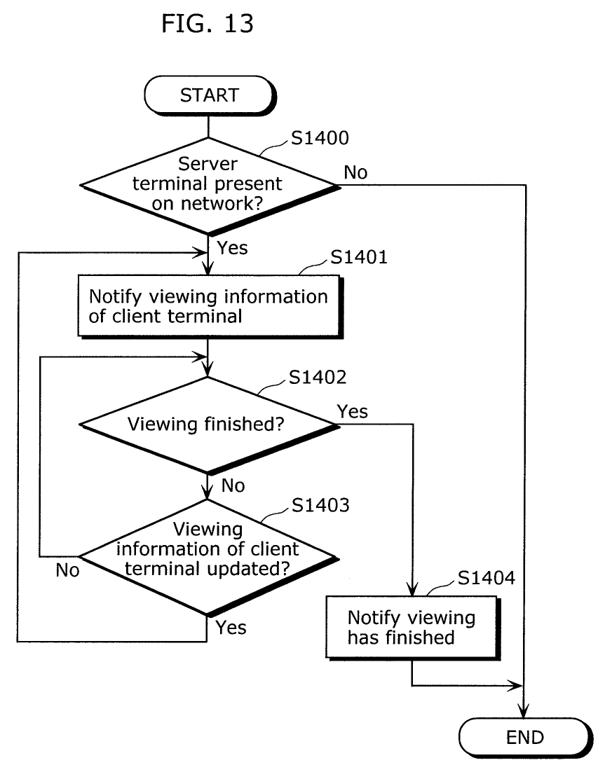

FIG. 13 is a flowchart showing a process operation related to the viewing information of the client terminal 105. To update the terminal-specific viewing information 1300 held by the terminal-specific viewing information managing unit 410 of the server terminal 102, the client terminal 105 notifies the server terminal 102 of the viewing information indicating the channel currently played by the client terminal 105 and viewed by the user. The viewing information is notified at a predetermined timing, such as at regular intervals or every time the channel of the client terminal is switched. The server terminal 102 updates the viewing information contained in the terminal-specific viewing information 1300 and associated with the client terminal which has made the above notification. As a result, by referring to the terminal-specific viewing information 1300, the server terminal 102 can identify the channel currently viewed by the user with the client terminal.

More specifically, the client terminal 105 first checks for presence of the server terminal 102 on the home network 104 to which the client terminal 105 itself is connected (Step S1400). In the case of judging that the server terminal 102 is not present (No in Step S1400), the client terminal 105 ends the process.

For example, the client terminal 105 packs a search command into an HTTP message and IP-packetizes the HTTP message according to the HTTP/TCP/IP protocol so as to broadcast the IP packet to a terminal apparatus connected to the home network 104. As a result, if the client terminal 105 receives an HTTP message containing a response command indicating that the terminal apparatus itself has a recording function, it judges that the server terminal 102 is present on the home network 104. Otherwise, the client terminal 105 judges that the server terminal 102 is not present on the home network 104. In the case of judging that the server terminal 102 is present on the home network 104 (Yes in Step S1400), the client terminal 105 notifies the server terminal 102 of the terminal identifier of the client terminal 105 and the viewing information indicating the channel currently played by the client terminal 105 and viewed by the user (Step S1401).

Here, the server terminal 102 forms and manages the terminal-specific viewing information 1300 held by the terminal-specific viewing information managing unit 410 in such a way that the terminal identifier received from the client terminal 105 is included as the terminal identifier 1301 and the viewing information (channel) received from the client terminal 105 is included as the current channel 1302b. It is to be noted that the update and rewriting of the terminal-specific viewing information 1300 are performed by the terminal-specific viewing information managing unit 410 of the server terminal 102.

Next, the client terminal 105 judges whether or not the playing of the content (program) has finished, that is, whether or not the user has finished the viewing (Step S1402). In the case of judging that the viewing has finished (Yes in Step S1402), the client terminal 105 notifies the server terminal 102 that the viewing has finished, and ends the process (Step S1404). On the other hand, in the case of judging that the viewing has not finished (No in Step S1402), the client terminal 105 judges whether or not the viewing information has been updated, that is, whether or not the played channel has been switched (Step S1403).

In the case of judging in Step S1403 that the viewing information has been updated (Yes in Step S1403), the client terminal 105 notifies the server terminal 102 of the terminal identifier of the client terminal 105 and the viewing information indicating the channel currently played by the client terminal 105 and viewed by the user (Step S1401). As a result, the server terminal 102 writes, in the terminal-specific viewing information 1300 held by the terminal-specific viewing information managing unit 410, the same channel as the existing current channel 1302b associated with the terminal identifier 1302 as the previous channel 1302a associated with the terminal identifier 1302 which is the same as the notified terminal identifier. In addition, the server terminal 102 updates the existing current channel 1302b associated with the terminal identifier 1302 to the newly notified channel. Meanwhile, in the case of judging in Step S1403 that the viewing information has not been updated (No in Step S1403), the client terminal 105 repeats the process from Step S1402.

This allows the terminal-specific viewing information managing unit 410 of the server terminal 102 to always hold the most up-to-date and correct terminal-specific viewing information 1300.

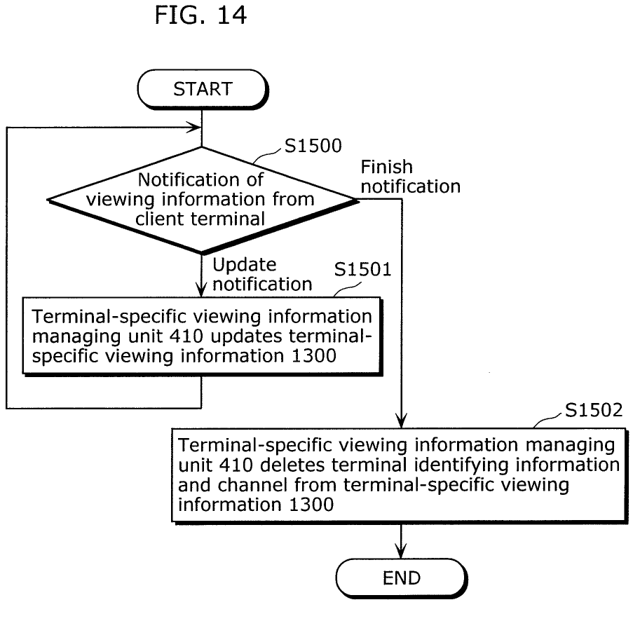

FIG. 14 is a flowchart showing the process performed by the server terminal 102 for updating the terminal-specific viewing information 1300 held by the terminal-specific viewing information managing unit 410.

The server terminal 102 performs the following in advance: it receives a search command; IP-packetizes, according to the HTTP/TCP/IP protocol, an HTTP message containing a response command indicating that the server terminal 102 itself has a recording function; and transmits the HTTP message to the client terminal 105 from which the search command was received, as a destination terminal. Thereafter, upon the receipt of a notification of the terminal identifier and viewing information (channel) from the destination client terminal 105, the server terminal 102 judges whether or not the notification indicates that the viewing has finished (Step S1500). When judging that the notification does not indicate the viewing has finished, that is, when the details of the notification are for an update of the terminal-specific viewing information 1300 (update notification in Step S1500), the server terminal 102 executes an after-mentioned process of Step S1501. On the other hand, when judging that the notification indicates the viewing has finished (finish notification in Step S1500), it executes an after-mentioned process of Step S1502.

In Step S1501, the server terminal 102 forms and manages the terminal-specific viewing information 1300 held by the terminal-specific viewing information managing unit 410 in such a way that the terminal identifier received from the client terminal 105 is included as the terminal identifier 1301 and the viewing information (channel) received from the client terminal 105 is included as the current channel 1302b (Step S1501). The server terminal 102 then executes the process again from Step S1500. It is to be noted that in the case where the terminal identifier received from the client terminal 105 is already included in the terminal-specific viewing information 1300 as the terminal identifier 1301, the server terminal 102 writes the same channel as the existing current channel 1302b to the terminal-specific viewing information 1300 as the previous channel 1302a and updates the existing current channel 1302b to the newly notified channel.

In Step S1502, the server terminal 102 deletes the same terminal identifier 1301 as the received terminal identifier and the previous channel 1302a and the current channel 1302b associated with the terminal identifier 1301 from the terminal-specific viewing information 1300 (Step S1502).

This process allows the server terminal 102 to identify, based on the terminal-specific viewing information 1300 held in the server terminal 102 itself, the channel currently viewed by the client terminal 105 and the channel viewed immediately before the current channel.

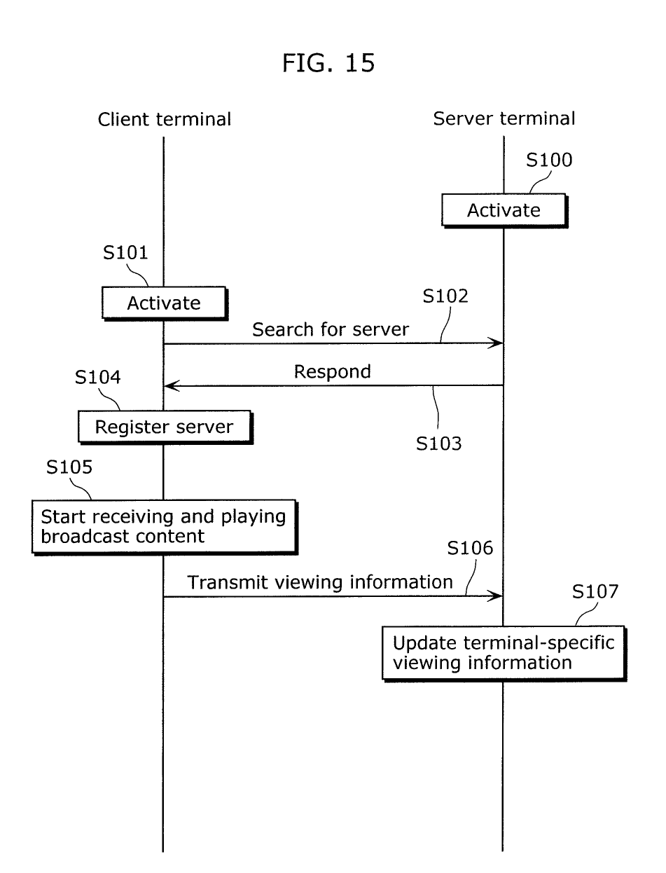

FIG. 15 is a sequence diagram showing an example of a process performed between the client terminal 105 and the server terminal 102 for updating the terminal-specific viewing information 1300.

First, the server terminal 102 is activated in response to a user operation (Step S100), and then the client terminal is activated in response to a user operation (Step S101). The activated client terminal 105 searches for a terminal (the server terminal 102) connected to the home network 104 and capable of recording a content and providing the recorded content (Step S102). When the server terminal 102 judges itself as the terminal being searched for by the client terminal 105, it responds to the client terminal 105 by transmitting the identifier of the server terminal 102 to the client terminal 105 (Step S103).

Upon the obtainment of the identifier of the server terminal 102, the client terminal 105 registers the identifier (Step S104). Then, when the client terminal 105 starts receiving and playing a content broadcast by the broadcast station system 100 (broadcast contents) in response to a user operation (Step S105), the client terminal 105 transmits viewing information indicating the channel of the content to the server terminal 102 associated with the identifier registered in Step S104 (Step S106).

Upon the receipt of the viewing information from the client terminal 105, the server terminal 102 updates the terminal-specific viewing information 1300 by writing the received viewing information into the terminal-specific viewing information 1300 as the current channel 1302b.

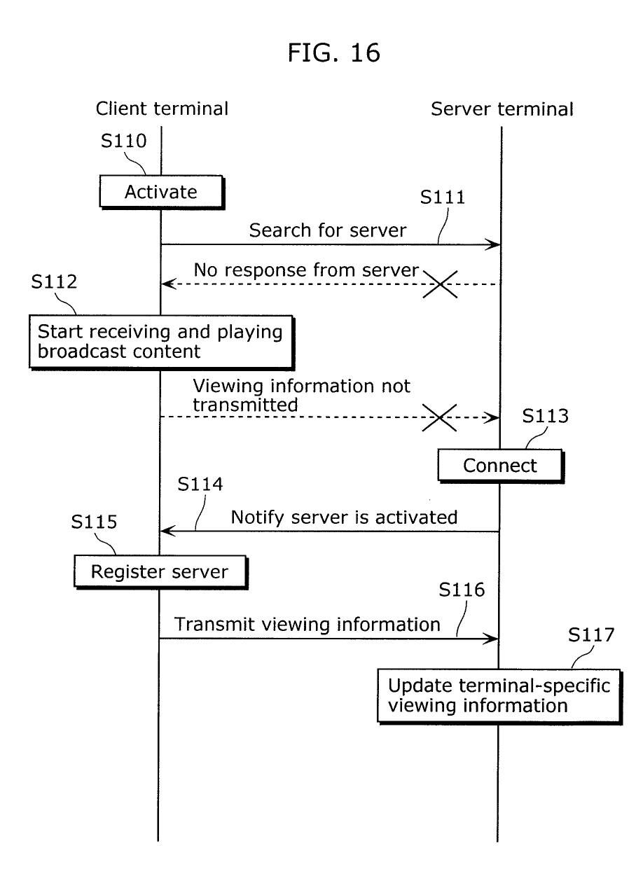

FIG. 16 is a sequence diagram showing another example of a process for updating the terminal-specific viewing information 1300, performed between the client terminal 105 and the server terminal 102.

First, the client terminal 105 is activated in response to a user operation (Step S110). The activated client terminal 105 searches for a terminal (server terminal 102) connected to the home network 104 and capable of recording a content and providing the recorded content (Step S111). In the case where the server terminal 102 is activated yet not connected to the home network 104, the server terminal 102 is not capable of providing the recorded content. Therefore, the server terminal 102 does not respond to the search by the client terminal 105.

As a result, upon a user operation, the client terminal 105 does not register the identifier of the server terminal 102, but starts receiving and playing a content broadcast by the broadcast station system 100 (broadcast content) (Step S112). Here, the client terminal 105 does not transmit the viewing information indicating the channel of the content being received and played, since the identifier of the server terminal 102 is not registered.

It is to be noted that when the search in Step S111 results in no response from the server terminal 102 for a predetermined time period, or when the server terminal 102 is disconnected from the home network 104, the client terminal 105 may give the user an alarm indicating that there is no server terminal 102 capable of proxy recording.

Thereafter, when the server terminal 102 is activated in response to a user operation (Step S113), the server terminal 102 transmits the identifier of the server terminal 102 to the client terminal 105 to notify that the server terminal 102 is now activated (Step S114).

Upon the obtainment of the identifier of the server terminal 102, the client terminal 105 registers the obtained identifier (Step S115) and transmits the viewing information indicating the channel of the content played since Step S112 to the server terminal 102 associated with the registered identifier (Step S116).

Upon the receipt of the viewing information from the client terminal 105, the server terminal 102 updates the terminal-specific viewing information 1300 by writing the viewing information into the terminal-specific viewing information 1300 as the current channel 1302b.

Next, the following describes a process performed when the emergency information is received, in the case where the server terminal 102 manages the viewing status of the client terminal 105.

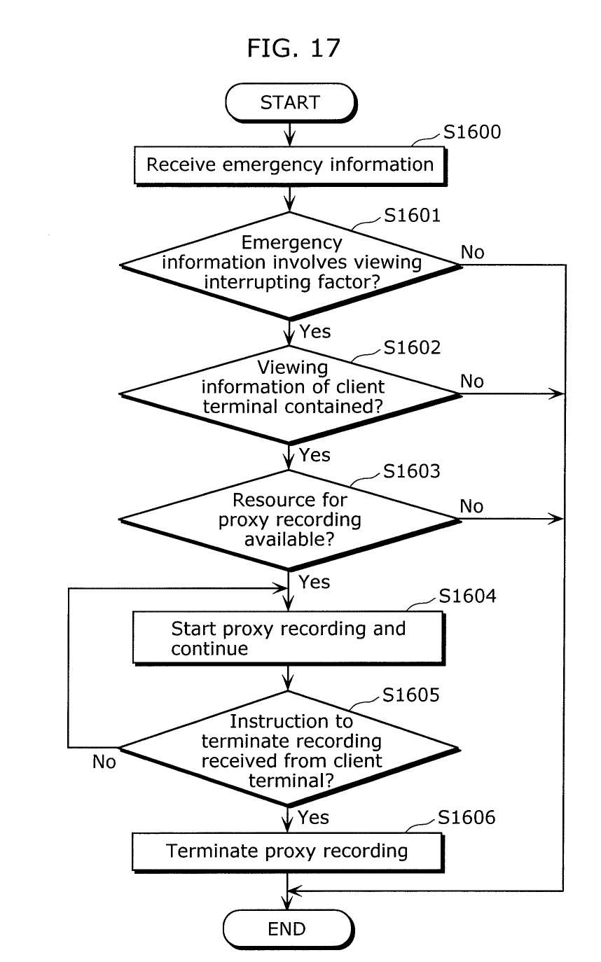

FIG. 17 is a flowchart showing an example of operations of the server terminal 102 performed when the emergency broadcast is received.

When the server terminal 102 receives the emergency information from the broadcast station system 100 and detects that the emergency broadcast has started (the emergency information reception has started) through the EAS module 419 (Step S1600), it judges whether or not the emergency information involves a factor that interrupts the viewing of a content (Step S1601). In the present embodiment, the factor that interrupts the viewing (viewing interrupting factor) is, for example, a switch from the audio of the currently viewed content to the emergency information audio, and a forcible channel selection from the currently viewed channel to another channel for the emergency information, which are performed for notifying the user of the emergency information but significantly interrupt the playing of the content currently viewed by the user. To be more specific, the EAS module 419 of the server terminal 102 judges whether or not a viewing interrupting factor is involved based on the above described control information contained in the emergency information. When judging that a viewing interrupting factor is involved in the above case (Yes in Step S1601), the server terminal 102 executes an after-mentioned process of Step S1602. On the other hand, in the case where, for example, the control information indicates that the emergency information text should be displayed on the video of the currently viewed content so as to notify the emergency information, the server terminal 102 judges that the emergency information containing the control information does not involve a viewing interrupting factor (No in Step S1601) and ends the process.

In the case of judging in Step S1601 that a viewing interrupting factor is involved, the server terminal 102 in Step S1602 refers to the terminal-specific viewing information 1300 to check whether or not it contains the viewing information (the previous channel 1302a) of the client terminal 105 (Step S1602). In the case of judging that the viewing information of the client terminal 105 is not contained (No in Step S1602), the server terminal 102 ends the process. In the case of judging that the viewing information of the client terminal 105 is contained (Yes in Step S1602), the server terminal 102 executes an after-mentioned process of Step S1603.

In Step S1603, having checked that the viewing information of the client terminal 105 is contained, the server terminal 102 first determines whether or not to perform the proxy recording, based on the proxy recording table 1000A shown in FIG. 7A. In the case of determining that the proxy recording is unnecessary, the server terminal 102 ends the process. On the other hand, in the case of determining that the proxy recording is necessary, the server terminal 102 refers to the management information 1200 of FIG. 8A or FIG. 8B to judge whether or not resources necessary for the proxy recording are available (Step S1603).

In the case of judging that the resources necessary for the proxy recording are unavailable (No in Step S1603), the server terminal 102 ends the process. On the other hand, in the case of judging that the resources necessary for the proxy recording are available (Yes in Step S1603), the server terminal 102 secures the resources necessary for the proxy recording and starts performing the proxy recording using the secured resources (Step S1604).

Next, the server terminal 102 judges whether or not an instruction to terminate the proxy recording is received from the client terminal 105 (Step S1605). In the case of judging that the instruction is not received (No in Step S1605), the server terminal 102 repeats the process from Step S1604 to continue the proxy recording. On the other hand, in the case of judging that the instruction is received (Yes in Step S1605), the server terminal 102 terminates the proxy recording (Step S1606) and ends the process after releasing the resources which were necessary for the proxy recording.

The processes from Step S1604 to S1606 enable the server terminal 102 to perform its function of starting the proxy recording and continuing with it until the instruction prompting to terminate the proxy recording is received.

It is to be noted that in the flowchart of FIG. 17, the condition for terminating the proxy recording in Step S1605 is the instruction from the client terminal 105, but it may be a different termination condition.

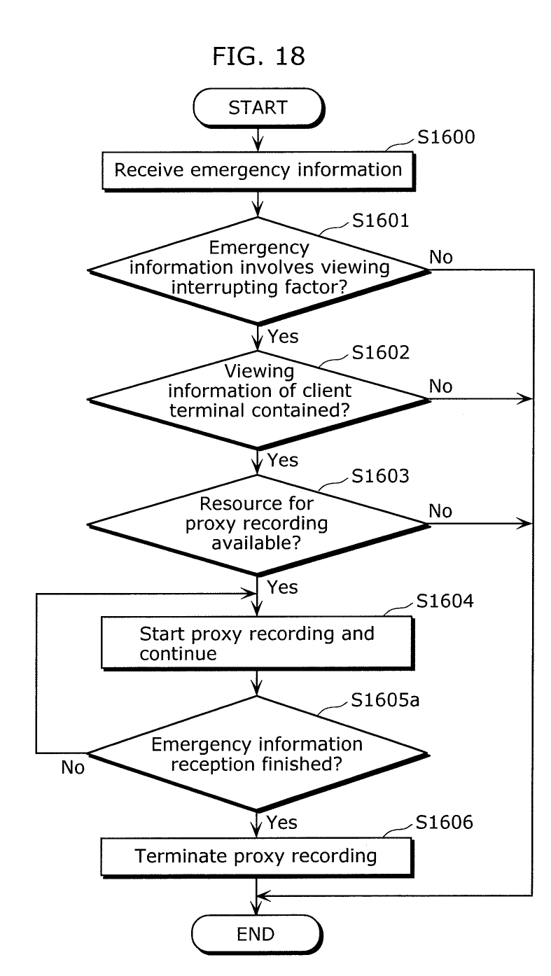

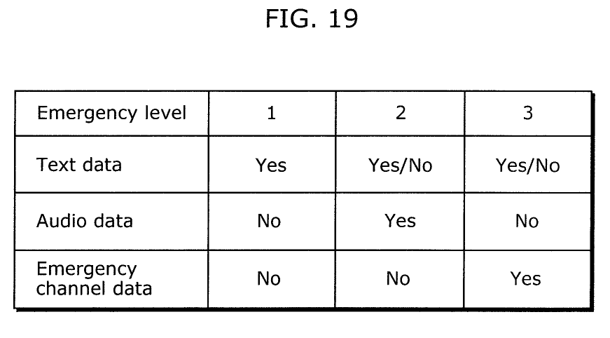

FIG. 18 is a flowchart showing another example of operations of the server terminal 102 performed when the emergency broadcast is received.

As in the flowchart shown in FIG. 17, the server terminal 102 executes the processes from Step S1600 to S1604. After the execution of the process in Step S1604, the server terminal 102 does not judge whether or not the instruction is received from the client terminal 105, but judges whether or not the emergency information reception has finished (Step S1605a). In the case of judging that the emergency information reception has not finished (No in Step S1605a), the server terminal 102 repeats the processes from Step S1604 to continue the proxy recording. On the other hand, in the case of judging that the emergency information reception has finished (Yes in Step S1605a), the server terminal 102 terminates the proxy recording (Step S1606) and ends the process after releasing the resources which were necessary for the proxy recording.

Now, the above mentioned emergency information and viewing interrupting factor shall be described in detail.

The broadcast station system 100 includes, in the emergency information, the control information indicating a notification method suitable for a given emergency level, and broadcasts the emergency information containing the control information. The notification method is a method for notifying the user of the emergency information while interrupting the playing of a content.

FIG. 19 is a table for describing the emergency levels of the emergency information.

The emergency information of an emergency level 1 includes text data. More specifically, this emergency information is to be notified to the user while interrupting the viewing of a content according to a notification method of displaying the text indicated by the text data through superimposition thereof on the video of the currently viewed content.

The emergency information of an emergency level 2 includes audio data. More specifically, this emergency information is to be notified to the user while interrupting the viewing of the contents according to a notification method of outputting the audio indicated by the audio data of the emergency information in place of the audio of the currently viewed contents. It is to be noted that as with the above described emergency information of the emergency level 1, the emergency information of the emergency level 2 may include text data and be notified through text display and audio output.

The emergency information of an emergency level 3 includes emergency channel data that indicates an emergency information channel. More specifically, this emergency information is to be notified to the user while interrupting the viewing of the contents according to a notification method of switching the channel of the currently viewed content to a channel indicated by the emergency channel data, that is, according to a notification method of forcibly selecting an emergency information channel. It is to be noted that as with the above described emergency information of the emergency level 1, the emergency information of the emergency level 3 may include text data and be notified through text display and forcible channel selection.

The server terminal 102 judges whether or not the emergency information involves a viewing interrupting factor based on a notification method indicated by the control information as described above. For example, when the emergency level of the emergency information is “2” or “3”, the notification of the emergency information causes significant interruption of the playing of the content currently viewed by the user. Thus the server terminal 102 judges that the notification method of the emergency information involves a viewing interrupting factor. On the other hand, when the emergency level of the emergency information is “1”, the notification of the emergency information does not cause significant interruption of the playing of the content currently viewed by the user. Thus the server terminal 102 judges that the notification method of the emergency information does not involve a viewing interrupting factor.

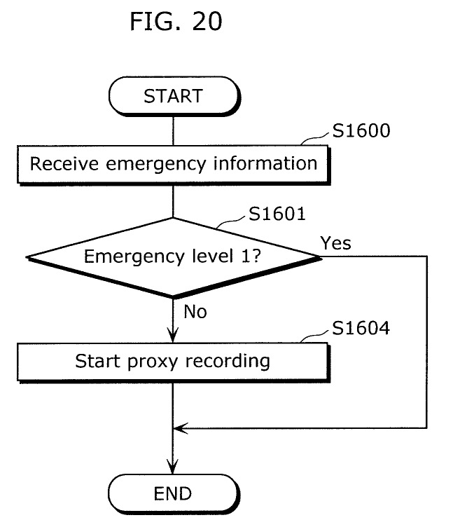

FIG. 20 is a flowchart showing detailed process operations in Step S1601 in FIGS. 17 and 18.

When the emergency information is received (Step S1600), the server terminal 102 judges whether or not the emergency level of the emergency information is “1” based on the notification method indicated by the control information contained in the emergency information (Step S1601). In the case of judging that the emergency level is “1” (Yes in Step S1601), that is, in the case of judging that the emergency information does not involve a viewing interrupting factor, the server terminal 102 ends the process without performing the proxy recording. On the other hand, in the case of judging that the emergency level is not “1” (No in Step S1601), that is, in the case of judging that the emergency information involves a viewing interrupting factor, the server terminal 102 starts the proxy recording (Step S1604).

In such a manner, the server terminal 102 of the present embodiment performs the proxy recording only when the emergency information involves a viewing interrupting factor. To put it differently, in the case where the notification of the emergency information to the client terminal 105 causes significant interruption of the playing or viewing of the broadcast content, the server terminal 102 performs the proxy recording, whereas in the case where the interruption of the playing or viewing is not so significant, it does not perform the proxy recording.

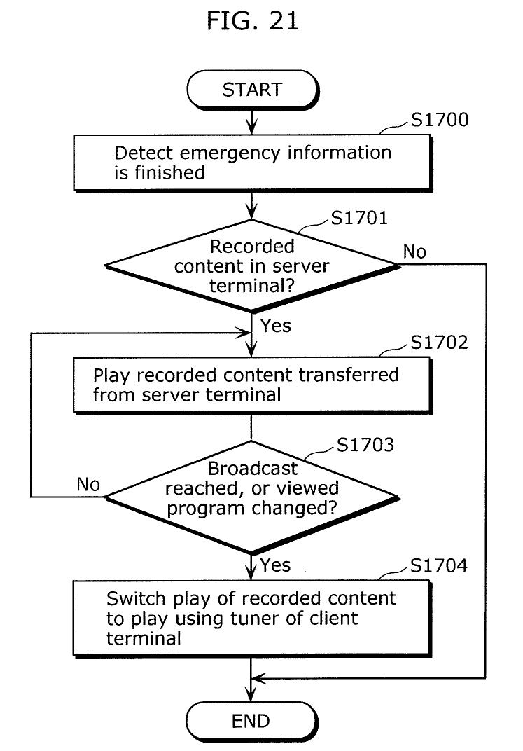

FIG. 21 is a flowchart showing an example of a process performed by the client terminal 105 for playing a recorded content.

When the client terminal 105 detects, while notifying the emergency information that interrupts the viewing of the broadcast content, that the emergency information is finished (the emergency broadcast is finished) (Step S1700), the client terminal 105 inquires the server terminal 102 about whether or not the server terminal 102 has a recorded content corresponding to the broadcast content (program) the viewing of which was interrupted by the emergency information notification (Step S1701). It is to be noted that a recorded content refers to a content recorded by the server terminal 102 by the time-shift recording (proxy recording) for the client terminal 105 according to the proxy recording table 1000A shown in FIG. 7A.

To be more specific, for example, the network control manager 509 of the client terminal 105 packs a recorded content obtainment command into an HTTP message and IP-packetizes the HTTP message according to the HTTP/TCP/IP protocol so as to transmit the IP packet to the server terminal 102 as a destination terminal. Thereafter, the network control manager 509 refers to the information packed into the HTTP message transmitted from the server terminal 102 to check whether or not the server terminal 102 has a recorded content that includes a portion recorded at the time when the emergency information was displayed.

In the case of judging that the server terminal 102 does not have a recorded content (No in Step S1701), the client terminal 105 terminates the process for playing the recorded content and receives from the broadcast station system 100 the broadcast content (program) originally viewed before the emergency information, from the current point. Then the client terminal 105 plays the broadcast content received.

On the other hand, in the case of judging that the server terminal 102 has a recorded content (Yes in Step S1701), the client terminal 105 requests the server terminal 102 for the recorded content and plays the recorded content transferred from the server terminal 102 (Step S1702). That is to say, the service manager 508 notifies the EAS listener 505 of the information (such as information listing recorded contents) packed into the HTTP message received from the server terminal 102, and the downloaded lava program 502 instructs the embedded middleware 507 to play a relevant recorded content from the beginning.

To be more specific, the network control manager 509 specifies the identifier (program identifier) associated with the relevant recorded content and the initial and last byte positions of the desired portion. The network control manager 509 packs into an HTTP message a command to obtain the portion between these byte positions out of the MPEG-2 transport streams that correspond to the relevant recorded content. Then, the network control manager 509 IP-packetizes the HTTP message according to the HTTP/TCP/IP protocol and transmits the IP packet to the server terminal 102. Thereafter, the network control manager 509 obtains MPEG-2 transport streams packed into an HTTP message from the server terminal 102. The obtained MPEG-2 transport streams correspond to the relevant content and are played by the service manager 508.

This enables, even when the emergency information notification interrupts the viewing of a program, the client terminal 105 having no recording function to play the program after the emergency information notification so that the user can view the program without being interrupted.

Next, the client terminal 105 judges whether or not the play position of the recorded content transferred from the server terminal 102 has reached the position of the content currently broadcast from the broadcast station system 100 (broadcast content) (Step S1703). The play position of the recorded content transferred from the server terminal 102 sometimes reaches, through a trick-play such as fast-forwarding by the client terminal 105, the position of the currently broadcast content to which the recorded content corresponds. Thus, as stated above, the client terminal 105 judges whether or not the play position of the recorded content has reached the position of the currently broadcast content. Further, the client terminal 105 also judges here whether or not there has been a change of the program, which is the content currently played and viewed by the user (viewed program).

In the case of judging that the play position of the recorded content has reached the position of the currently broadcast content, or in the case of judging that there has been a change of the viewed program (Yes in Step S1703), the client terminal 105 switches the playing of the recorded content to the play performed using the tuner of the client terminal 105, that is, the playing of the content broadcast from the broadcast station system 100 (Step S1704). Furthermore, at this time, the client terminal 105 instructs the server terminal 102 to terminate the recording. On the other hand, in the case of judging that the play position of the recorded content has not reached the position of the currently broadcast content, or in the case of judging that no change has been made to the viewed program (No in Step S1703), the client terminal 105 repeats the processes from Step S1702.

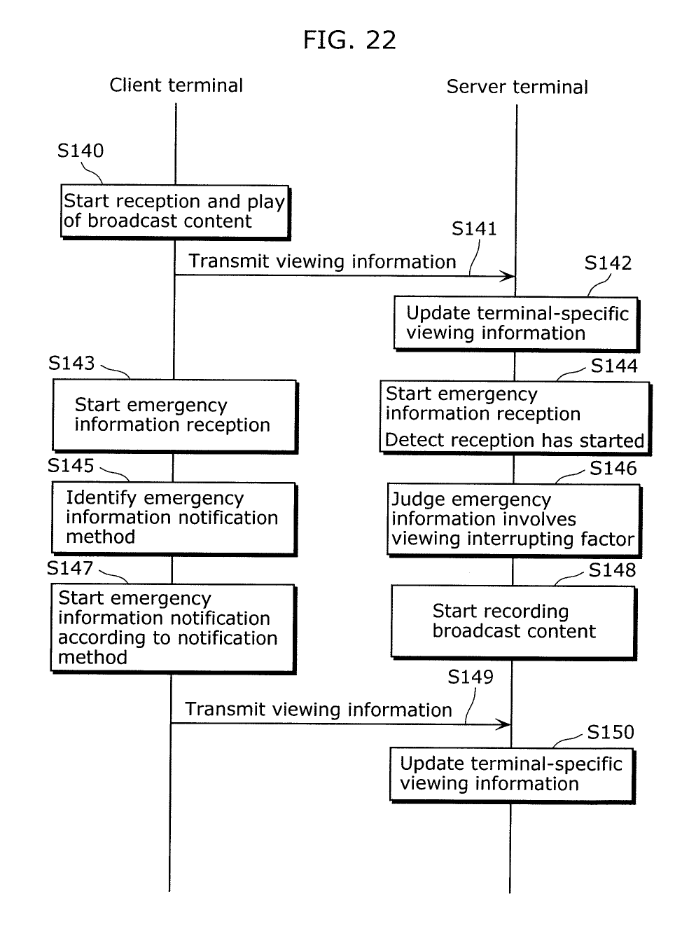

FIG. 22 is a sequence diagram showing a process performed by the client terminal 105 and the server terminal 102 of the present embodiment to start recording.

First, the client terminal 105 starts receiving and playing a broadcast content (Step S140), and transmits to the server terminal 102 the identifier of the client terminal 105 and viewing information indicating the channel of the broadcast content (Step S141). Upon the obtainment of the identifier and viewing information from the client terminal 105, the server terminal 102 updates the terminal-specific viewing information 1300 based on the obtained identifier and viewing information (Step S142).

Here, the client terminal 105 starts receiving the emergency information (Step S143). Meanwhile, the server terminal 102 also starts receiving the emergency information and detects that the reception has started (Step S144).

Having started receiving the emergency information in Step S143, the client terminal 105 identifies a notification method of the emergency information based on control information contained in the emergency information (Step S145) and starts notification of the emergency information according to the identified notification method (Step S147). In this case, the client terminal 105 identifies, for example, forcible channel selection as the notification method and switches the channel from the channel used for the play, started in Step S140, of the broadcast content to the emergency information channel. As a result, the client terminal 105 transmits the viewing information indicating the emergency information channel to the server terminal 102 (Step S149).

Having detected in Step S144 that the emergency information reception has started, the server terminal 102 judges that the notification method (forcible channel selection) of the emergency information involves a viewing interrupting factor based on the control information contained in the emergency information (Step S146) and starts recording the broadcast content on behalf of the client terminal 105 (Step S148). Then, upon the receipt of the viewing information transmitted in Step S149, the server terminal 102 updates the terminal-specific viewing information 1300 so that the received viewing information is contained therein (Step S150).

In the example shown in FIG. 22, the server terminal 102 starts recording the broadcast content prior to the update of the terminal-specific viewing information 1300 in Step S150. It is to be noted, however, that the recording of the broadcast content may be started when it is checked, after the terminal-specific viewing information 1300 is updated, that the current channel 1302b of the terminal-specific viewing information 1300 indicates the emergency information channel.

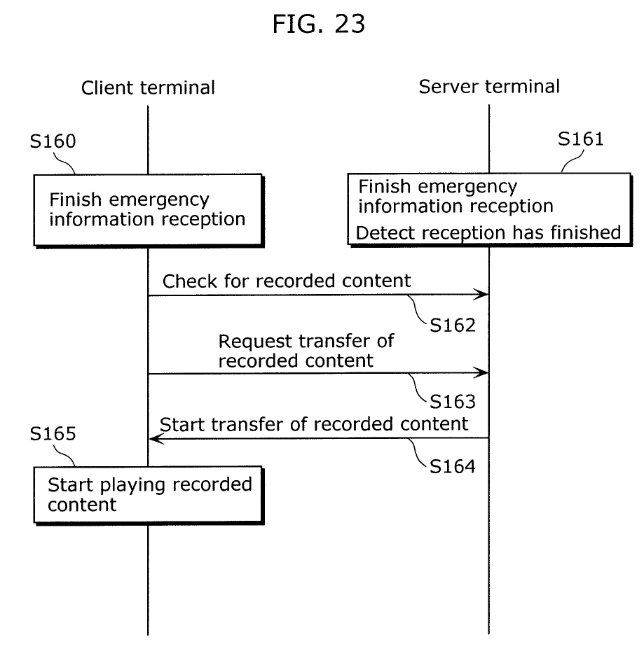

FIG. 23 is a sequence diagram showing a process to start playing a recorded content, performed by the client terminal 105 and the server terminal 102 of the present embodiment.

First, the client terminal 105 finishes the emergency information reception since the emergency broadcast is finished (Step S160). Meanwhile, the server terminal 102 also finishes the emergency information reception and detects that the reception is finished (Step S161).

Having finished the emergency information reception in Step S160, the client terminal 105 checks that the server terminal 102 has a record content (Step S162) and requests the server terminal 102 to transfer the recorded content (Step S163). In response to the request from the client terminal 105, the server terminal 102 starts transferring the recorded content (Step S164). The client terminal 105 receives the recorded content from the server terminal 102 and starts playing the recorded content (Step S165).

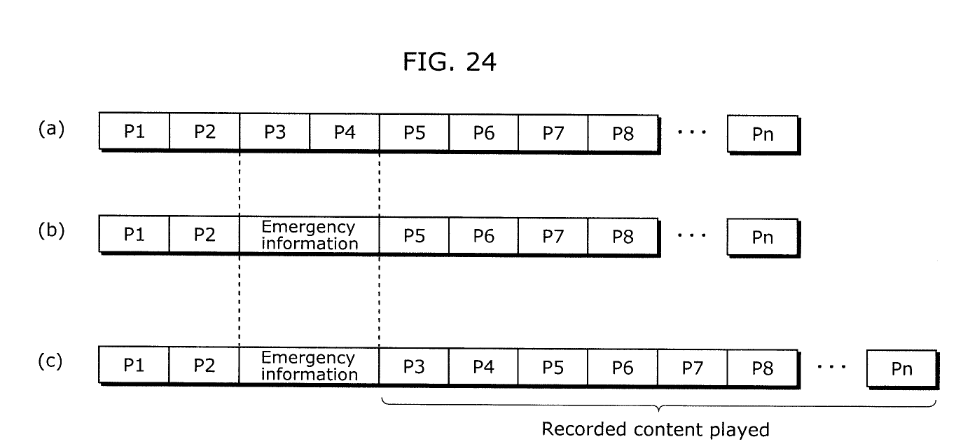

FIG. 24 is a diagram for describing a content played according to the present embodiment.

For example, when the emergency information is not broadcast, the client terminal 105 displays pictures P1, P2, . . . Pn sequentially as shown in FIG. 24(a) by playing a currently broadcast content. When the emergency information is broadcast and the proxy recording is not performed by the server terminal 102, the client terminal 105 interrupts the playing of the pictures P3 and P4 of the currently broadcast content and displays the video of the emergency information in place of the pictures P3 and P4 as shown in FIG. 24(b). This causes the user of the client terminal 105 to miss out on the pictures P3 and P4 of the content.

However, according to the present embodiment, the server terminal 102 performs the proxy recording when the emergency information is broadcast. In other words, the server terminal 102 records, out of the currently broadcast content, a portion which is broadcast from the point at which the emergency information reception has started, namely, the pictures P3, P4, . . . Pn. Then, as shown in FIG. 24(c), the client terminal 105 sequentially displays the pictures P3, P4, . . . Pn recorded by the server terminal 102, after the display of the video of the emergency information is finished. This allows the user of the client terminal 105 to view the entire broadcast content without missing it out.

In the above described manner, according to the present embodiment, even the client terminal 105 having no recording function causes the server terminal 102, connected to the client terminal 105 via the home network 104 and having a recording function, to perform the proxy recording. Then, after the emergency information notification is finished, the client terminal 105 plays the content recorded by the proxy recording by the server terminal 102 via the network. Consequently, the user of the client terminal 105 can view the content he or she could not view due to the emergency information notification.

It is to be noted that according to the present embodiment, in the server terminal 102, the EAS module 419 is included as the emergency information detecting unit, the network control manager 411 and the recording manager 408 are included as the receiving and recording unit, and the network control manager 411 is included as the recorded content transmitting unit. Further, in the client terminal 105, the service manager 508 is included as the broadcast content playing unit, the EAS module 517 is included as the emergency information receiving unit, the EAS 512 is included as the emergency information notifying unit, and the service manager 508 and the network control manager 509 are included as the recorded content playing unit. Furthermore, in the server terminal 102, the EAS module 419 is included as the notification method identifying unit, and in the client terminal 105, the network control manager 509 is included as the viewing information transmitting unit.

### Embodiment 2

In Embodiment 1, after the emergency information notification, the client terminal 105 inquires the server terminal 102 about whether or not the server terminal 102 has a recorded content corresponding to a content, the viewing of which was interrupted by the emergency information notification. In contrast, the present embodiment is characterized in that the server terminal 102 autonomously notifies the client terminal 105 that it has performed the proxy recording.

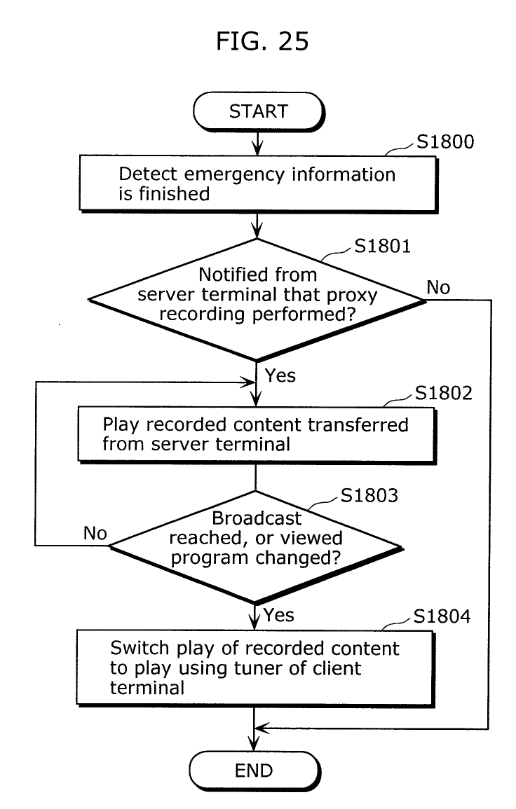

FIG. 25 is a flowchart showing an example of a process for playing a recorded content, performed by the client terminal 105 of the present embodiment.

In the case where the client terminal 105 detects, while notifying the emergency information that interrupts the viewing of the content, that the emergency information is finished (the emergency broadcast is finished) (Step S1800), the client terminal 105 judges whether or not a notification is received from the server terminal 102 indicating that the server terminal 102 has a recorded content corresponding to the content (program) the viewing of which was interrupted, that is, a notification that the proxy recording has been performed for the content (program) the viewing of which was interrupted (Step S1801).

To be more specific, when the emergency information is finished, the EAS 414 of the server terminal 102 inquires the recording manager 408 and the terminal-specific viewing information managing unit 410 about whether or not there is a recorded content, and when there is a recorded content, the network control manager 411 transmits to the client terminal 105 information (recording notifying information) indicating that recording has been performed on behalf of the client terminal 105. It is to be noted that the server terminal 102 may transmit information regarding the recorded content to the client terminal 105 as well as the recording notifying information.

In the case of judging that the recording notifying information is received from the server terminal 102, that is, in the case of judging that the notification is received indicating that the proxy recording has been performed (Yes in Step S1801), the client terminal 105 requests the server terminal 102 for the recorded content and plays the recorded content transferred from the server terminal 102 (Step S1802). On the other hand, in the case of judging that the recording notifying information is not received from the server terminal 102 even after a predetermined period elapses from when the emergency information is finished (No in Step S1801), the client terminal 105 does not perform the process of playing the recorded content, but receives from the broadcast station system 100 the broadcast content (program) originally viewed before the emergency information, from the current point. Then the client terminal 105 plays the broadcast content received.

Then, the client terminal 105 performs the same processes as those in Steps S1703 and S1704 shown in FIG. 21 of Embodiment 1 (Steps S1803 and S1804).

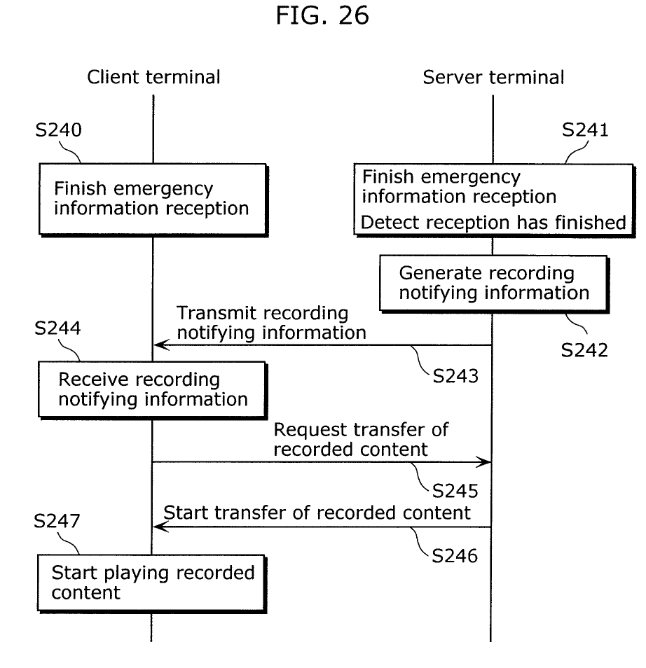

It is to be noted that Steps S1802, S1803 and S1804 are the same as Steps S1702, S1703 and S1704, respectively, and thus detailed descriptions of Steps S1802 to S1804 shall be omitted. FIG. 26 is a sequence diagram showing a process to start playing a recorded content, performed by the client terminal 105 and the server terminal 102 of the present embodiment.

First, the client terminal 105 finishes the emergency information reception since the emergency broadcast is finished (Step S240). Meanwhile, the server terminal 102 also finishes the emergency information reception and detects that the reception has finished (Step S241). It is to be noted that the server terminal 102 generates the above described recording notifying information (Step S242) and transmits the recording notifying information to the client terminal 105 (Step S243).

When the client terminal 105, which has finished the emergency information reception in Step S240, receives the recording notifying information from the server terminal 102 (Step S244), it requests the server terminal 102 to transfer the recorded content (Step S245). In response to the request from the client terminal 105, the server terminal 102 starts transferring the recorded content (Step S246). The client terminal 105 receives the recorded content from the server terminal 102 and starts playing it (Step S247).

As described above, in the example illustrated in FIG. 26, the request for the server terminal 102 to transfer the recorded content is issued by the client terminal 105 immediately after the recording notifying information is received. As a result, out of the broadcast content played immediately before the emergency information notification, a portion which is broadcast from the point when the emergency information notification has started can be played as the recorded content immediately after the emergency information notification is finished.

It is to be noted that instead of requesting the server terminal 102 to transfer the recorded content immediately after receiving the recording notifying information, the client terminal 105 may make the request upon a user operation.

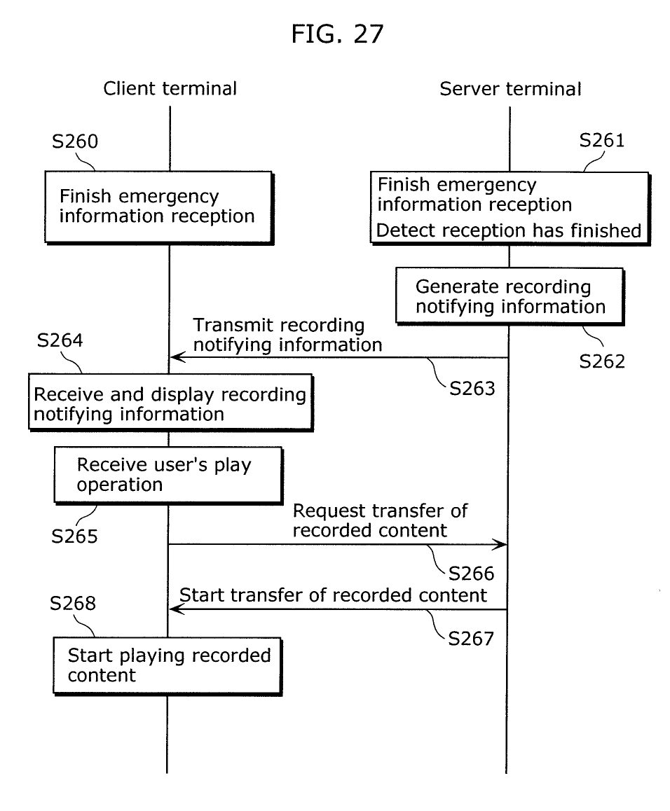

FIG. 27 is a sequence diagram showing another example of a process to start playing a recorded content, performed by the client terminal 105 and the server terminal 102 of the present embodiment.

First, the client terminal 105 finishes the emergency information reception since the emergency broadcast is finished (Step S260). Meanwhile, the server terminal 102 also finishes the emergency information reception and detects that the reception has finished (Step S261). Then, the server terminal 102 generates the above described recording notifying information (Step S262) and transmits the recording notifying information to the client terminal 105 (Step S263).

The client terminal 105 receives the recording notifying information from the server terminal 102 and displays the details of the recording notifying information (Step S264). For example, the recording notifying information indicates that the server terminal 102 has a recorded content and indicates information regarding the recorded content such as the program name and the recording start time. In Step S264, the client terminal 105 displays, using text, the fact that there is a recorded content and the program name and recording start time of the recorded content, for example.

By seeing such a display, the user understands that there is a recorded content, and thus operates the client terminal 105 so that it starts playing the recorded content. Such a user operation is made at a timing desired by the user after the details of the recording notifying information are displayed. The client terminal 105 deletes the display after a certain period of time, and receives from the broadcast station system 100 the broadcast content (program) originally viewed by the user before the emergency information, from the current point. Then the client terminal 105 plays the broadcast content received.

Upon the user operation (Step S265), the client terminal 105 requests the server terminal 102 to transfer the recorded content (Step S266). In response to the request from the client terminal 105, the server terminal 102 starts transferring the recorded content (Step S267). The client terminal 105 receives the recorded content from the server terminal 102 and starts playing it (Step S268).

In the above described manner, in the present embodiment, the server terminal 102 autonomously transmits the recording notifying information to the client terminal 105 after the emergency information reception is finished. Consequently, unlike Embodiment 1, the client terminal 105 does not need a function for inquiring, after the emergency information reception is finished, the server terminal 102 about whether or not it has a recorded content. As a result, the configuration of the client terminal 105 can be simplified, and the process load thereof can be reduced.

### Embodiment 3

In Embodiments 1 and 2, the server terminal 102 detects the start and finish of the emergency information reception, and takes the initiative in performing the proxy recording and transferring the recorded content. The present embodiment is characterized in that the client terminal 105 detects the start and finish of the emergency information reception and proactively causes the server terminal 102 to perform the proxy recording and transfer the recorded content.

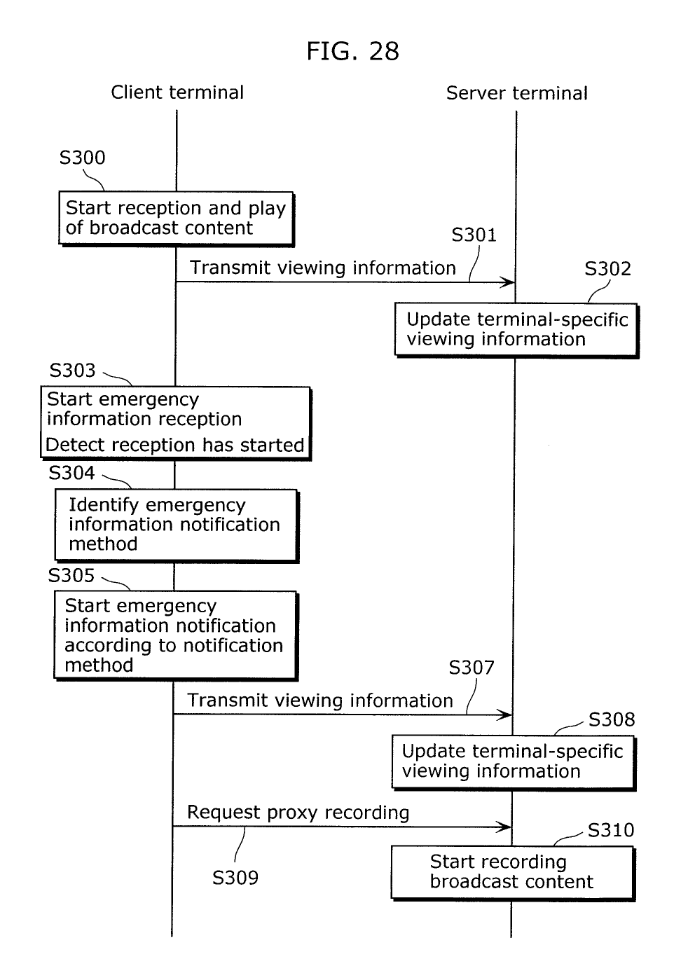

FIG. 28 is a sequence diagram showing a record starting process performed by the client terminal 105 and the server terminal 102 of the present embodiment.

First, the client terminal 105 starts receiving and playing a broadcast content (Step S300), and transmits to the server terminal 102 the identifier of the client terminal 105 and viewing information indicating the channel of the broadcast content (Step S301). Upon the receipt of the identifier and viewing information from the client terminal 105, the server terminal 102 updates the terminal-specific viewing information 1300 based on the received identifier and viewing information (Step S302).

Then, the client terminal 105 starts receiving the emergency information and detects that the reception has started (Step S303). Further, the client terminal 105 identifies, based on control information contained in the emergency information, a method of notifying the emergency information (Step S304), and starts notifying the emergency information according to the identified notification method (Step S305). In this case, the client terminal 105 identifies forcible channel selection, for example, as the notification method and switches the channel from the channel used for the play, started in Step S300, of the broadcast content to an emergency information channel. As a result, the client terminal 105 transmits the viewing information indicating the emergency information channel to the server terminal 102 (Step S307). Further, the client terminal 105 judges that the notification method (forcible channel selection) for the emergency information involves a viewing interrupting factor, and thus requests the server terminal 102 to perform the proxy recording (Step S309). To be more specific, the client terminal 105 transmits to the server terminal 102 the viewing information indicating the channel of the broadcast content the reception and playing of which have started in Step S300, and requests the server terminal 102 to record the content broadcast on the channel indicated by the viewing information.

Upon the receipt of the viewing information transmitted in Step S307, the server terminal 102 updates the terminal-specific viewing information 1300 so that the received viewing information is contained therein (Step 5308). In addition, in response to the request for the proxy recording, the server terminal 102 starts recording, out of the broadcast content the reception and playing of which have started in Step S300, a portion which is broadcast from the time point of receiving the request (Step S310). That is to say, the server terminal 102 receives the viewing information which is transmitted from the client terminal 105 when the proxy recording is requested, and starts recording the content broadcast on the channel indicated by the viewing information.

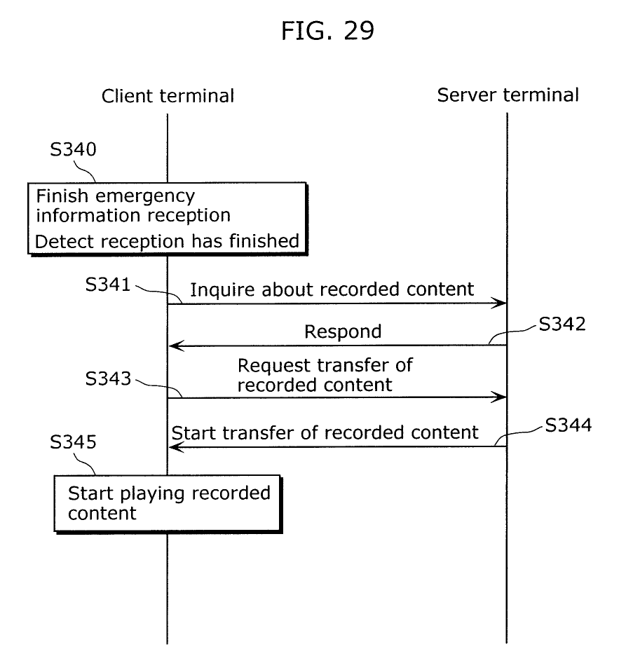

FIG. 29 is a sequence diagram showing a process to start playing a recorded content, performed by the client terminal 105 and the server terminal 102 of the present embodiment. First, the client terminal 105 finishes the emergency information reception since the emergency broadcast is finished, and detects that the reception has ended (Step S340). Then the client terminal 105 inquires the server terminal 102 about whether or not the server terminal 102 has a recorded content (Step S341).

When the server terminal 102 has a recorded content, the server terminal 102 responds to the inquiry from the client terminal 105 by informing that it has a recorded content (Step S342). Having received the response, the client terminal 105 requests the server terminal 102 to transfer the recorded content (Step S343). In response to the request from the client terminal 105, the server terminal 102 starts transferring the recorded content (Step S344). The client terminal 105 receives the recorded content from the server terminal 102 and starts playing it (Step S345).

As described in the example illustrated in FIG. 29, after the emergency information reception is finished, the client terminal 105 immediately requests, in the case where the server terminal 102 has a recorded content, the server terminal 102 to transfer the recorded content. Therefore, immediately after the emergency information notification, it is possible to play, out of the broadcast content played before the emergency information notification, the portion which is broadcast from the point when the emergency information notification has started.

It is to be noted that the timing to request the server terminal 102 to transfer the recorded content is not limited to immediately after the emergency information reception is finished, but may be upon a user operation.

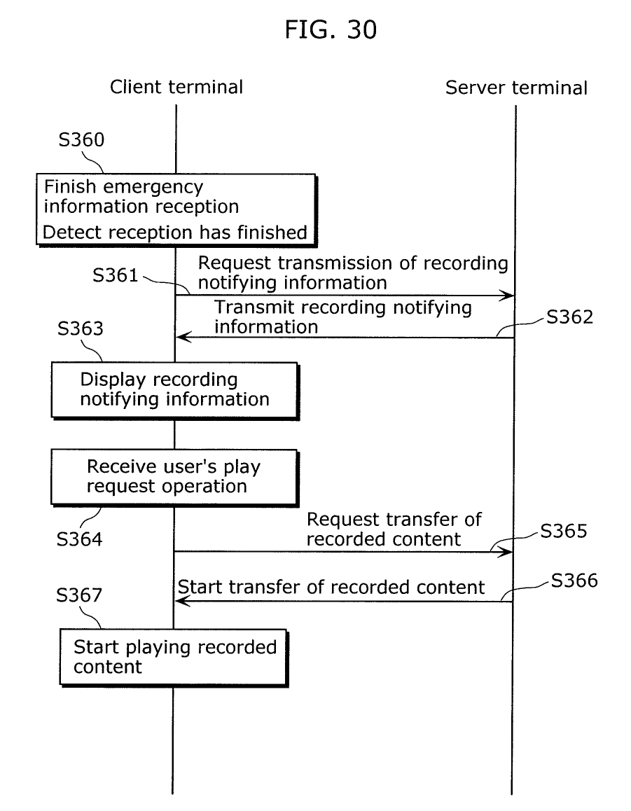

FIG. 30 is a sequence diagram showing another example of a process to start playing a recorded content, performed by the client terminal 105 and the server terminal 102 of the present embodiment.

First, the client terminal 105 finishes the emergency information reception since the emergency broadcast is finished and detects that the reception has finished (Step S360). Then the client terminal 105 requests the server terminal 102 to transmit the above described recording notifying information (Step S361). In response to the request from the client terminal 105, the server terminal 102 transmits the recording notifying information to the client terminal 105 in the case where the server terminal 102 has a recorded content (Step S362).

The client terminal 105 receives the recording notifying information from the server terminal 102 and displays the details of the recording notifying information (Step S363). For example, the recording notifying information indicates that the server terminal 102 has a recorded content and indicates information regarding the recorded content such as the program name and the recording start time. Therefore, in Step S363, the client terminal 105 displays, using text for example, the fact that there is a recorded content, and the program name and recording start time of the recorded content.

By seeing such a display, the user understands that there is a recorded content and operates the client terminal 105 so that it starts playing the recorded content. Such a user operation is made at a timing desired by the user after the details of the recording notifying information are displayed. The client terminal 105 deletes the display after a certain period of time and receives from the broadcast station system 100 the broadcast content (program) originally viewed by the user before the emergency information, from the current point. Then the client terminal 105 plays the received broadcast content.

Upon the user operation (Step S364), the client terminal 105 requests the server terminal 102 to transfer the recorded content (Step S365). In response to the request from the client terminal 105, the server terminal 102 starts transferring the recorded content (Step S366). The client terminal 105 receives the recorded content from the server terminal 102 and starts playing it (Step S367).

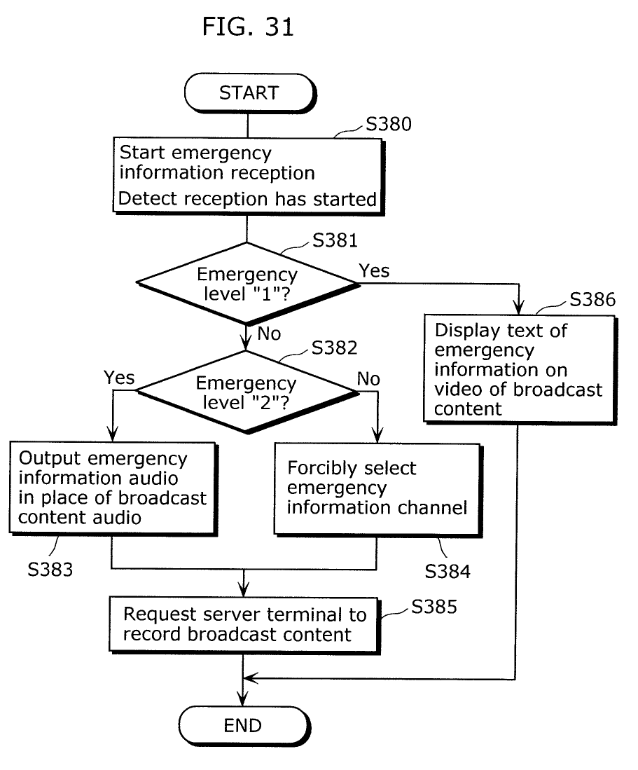

FIG. 31 is a flowchart showing process operations performed by the client terminal 105 of the present embodiment when it starts receiving the emergency information.

First, the client terminal 105 starts receiving the emergency information and detects that the reception has started (Step S380). Next, the client terminal 105 judges whether or not the emergency level of the emergency information is “1” based on a notification method indicated by control information contained in the emergency information (Step S381). That is to say, the client terminal 105 judges whether or not the emergency level of the emergency information is “1” so as to judge whether or not the notification method for the emergency information involves a viewing interrupting factor. In the case of judging that the emergency level is not “1” (No in Step S381), that is, judging that the notification method for the emergency information involves a viewing interrupting factor, the client terminal 105 further judges whether or not the emergency level of the emergency information is “2” (Step S382).

In the case of judging that the emergency level is “2” (Yes in Step S382), the client terminal 105 outputs audio for the emergency information in place of the audio for the currently received and played broadcast content (Step S383). On the other hand, in the case of judging in S382 that the emergency level is not “2”, that is, judging that the emergency level is “3” (No in Step S382), the client terminal 105 forcibly selects the emergency information channel (Step S384). To be more specific, the client terminal 105 switches the channel from the channel for the broadcast content played thus far to the emergency information channel indicated by the control information contained in the emergency information.

Further, immediately after starting the processes of Steps S383 and S384, the client terminal 105 requests the server terminal 102 to record the broadcast content received and played thus far (Step S385).

In the case of judging in Step S381 that the emergency level is “1” (Yes in Step S381), that is, judging that the notification method for the emergency information does not involve a viewing interrupting factor, the client terminal 105 does not request the server terminal 102 to record the broadcast content, but displays the emergency information by superimposing text of the emergency information on the video of the currently received and played broadcast content (Step S386).

In the above described manner, the client terminal 105 of the present embodiment determines, according to the emergency level of the emergency information, whether or not to request the server terminal 102 to record broadcast content. That is to say, when the emergency level of the emergency information is “2” or “3”, the playing of the broadcast content is significantly interrupted, and thus the client terminal 105 requests the server terminal 102 to record the broadcast content. On the other hand, when the emergency level is “1”, the playing of the broadcast content is not significantly interrupted, and thus the client terminal 105 does not request the server terminal 102 to record the broadcast content.

It is to be noted that in the server terminal 102 of the present embodiment, the network control manager 411 and the recording manager 408 are included as the receiving and recording unit, and the network control manager 411 is included as the recorded content transmitting unit. Further, in the client terminal 105, the service manager 508 is included as the broadcast content playing unit, the EAS module 517 as the emergency information receiving unit, the EAS 512 as the emergency information notifying unit, the network control manager 509 as the recording instructing unit, and the service manager 508 and the network control manager 509 as the recorded content playing unit. Furthermore, in the client terminal 105, the network control manager 509 is included as the server registering unit, alarming unit, and viewing information transmitting unit.

Although the recording and playing system of the present invention has been described based on Embodiments 1 to 3, the present invention is not limited to these embodiments.

For example, although Embodiments 1 to 3 have shown that the server terminal 102 performs the proxy recording for one client terminal 105 when resources (such as a tuner) are available, it may simultaneously perform the proxy recording for plural client terminals 105 connected to the home network 104. Further, when there is a lack of resources necessary for performing the proxy recording for plural client terminals 105, the server terminal 102 may arbitrate the contest for using resources of the server terminal 102 between the client terminals 105.

For example, the server terminal 102 may prioritize the client terminals 105 in advance, and when the contest arises, it may determine whether or not to perform the proxy recording for each of the client terminals 105 based on the predetermined priority.

Another approach may be that the server terminal 102 prioritizes the users of the client terminals 105 in advance, and when the contest arises, it determines whether or not to perform the proxy recording for each of the client terminals 105 based on the predetermined priority. In such cases, information regarding the priorities is desirably notified to the server terminal 102 by each of the client terminals 105 and managed in association with, for example, information regarding each of the client terminals 105.

Further, the above described arbitrating function may be incorporated in the function of the recording manager. Alternatively, an API having a separate function (API dedicated for the arbitration, for example (not shown)) may be incorporated in the server terminal 102.

Furthermore, although Embodiments 1 to 3 have shown that the server terminal 102 performs the proxy recording by the time-shift recording, it may perform the proxy recording by, instead of the time-shift recording, performing a type of recording where a recorded content is held until an explicit delete instruction is received. In that case, the content may be deleted through a deletion process designated by the user when, in the series of sequences, the process returns to the playing of the originally viewed broadcast content from the current point. Another way may be that the deletion is automatically performed by the server terminal 102. Furthermore, the server terminal 102 may save the content as a recorded content, and explicitly delete it through a single operation of the server terminal 102 or a remote operation from the client terminal 105.

Further, Embodiments 1 to 3 have shown that the server terminal 102 continues the proxy recording (time-shift recording) according to the proxy recording table 1000A until it receives an instruction to terminate the recording from the client terminal 105. However, the server terminal 102 may terminate the proxy recording when the program (content) finishes, without receiving the instruction from the client terminal 105. In that case, the server terminal 102 identifies the program viewed by the client terminal 105 and the time at which the program will finish (finish time) based on the EPG, the channel indicated by the viewing information received from the client terminal 105, and the time at which the emergency information was received. Then the server terminal 102 terminates the proxy recording when the current time reaches the identified finish time. This enables the client terminal 105 to reliably play, out of the entire program which is a broadcast content, a portion which is broadcast from the start of the emergency information notification to the end of the program, as a recorded content. That is to say, this allows the user of the client terminal 105 to surely view the program to the end without missing it out.

Moreover, when the recording manager 408 starts the proxy recording, the server terminal 102 according to Embodiments 1 to 3 may transmit recording start information to the client terminal 105 indicating that the proxy recording has started. In that case, upon the receipt of the recording start information, the client terminal 105 displays in text the details indicated by the recording start information. Further, the recording start information may contain the name of the content (program) recorded, the recording start time, and so on to be displayed by the client terminal 105.

Moreover, when the recording manager 408 terminates the proxy recording, the server terminal 102 according to Embodiments 1 to 3 may transmit recording termination information to the client terminal 105 indicating that the proxy recording is terminated. In that case, upon the receipt of the recording termination information, the client terminal 105 displays in text the details indicated by the recording termination information. Further, the recording termination information may contain the name of the recorded content (program), the recording termination time, and so on to be displayed by the client terminal 105.

It is to be noted that the transmission of the above mentioned recording start information or recording termination information is performed by the network control manager 411 which is included in the server terminal 102 either as the recording start information transmitting unit or recording termination information transmitting unit. Further, the display of the information is performed by the network control manager 509 which is included in the client terminal 105 as the recording start displaying unit or recording termination displaying unit.

Furthermore, Embodiment 3 has shown that the client terminal 105 determines, according to the emergency level of the emergency information (notification method), whether or not to request the server terminal 102 to perform the proxy recording, and that upon the receipt of the request for the proxy recording, the server terminal 102 reliably performs the proxy recording. However, even upon the receipt of the request for the proxy recording, the server terminal 102 itself may determine whether or not to actually perform the proxy recording. In that case, the client terminal 105 identifies the notification method for the emergency information (such as forcible channel selection) based on the control information contained in the emergency information, and informs the server terminal 102 of the identified notification method as well as requesting the server terminal 102 to perform the proxy recording. It is to be noted that the client terminal 105 here informs the server terminal 102 of the notification method and makes a request for the proxy recording without judging whether or not the notification method for the emergency information involves a viewing interrupting factor. The informing of the notification method is performed by the network control manager 509 which is included in the client terminal 105 as the notification method informing unit. When the server terminal 102 receives the request for the proxy recording and is informed of the notification method, it judges whether or not the informed notification method significantly interrupts the client terminal 105 from playing or viewing the broadcast content, that is, whether or not the informed notification method involves a viewing interrupting factor. In the case of judging that the playing or viewing of the broadcast content is significantly interrupted, that is, judging that the notification method for the emergency information involves a viewing interrupting factor, the server terminal 102 starts the proxy recording; otherwise, it does not perform the proxy recording.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The recording and playing system according to the present invention achieves an advantageous effect of preventing, even when a client terminal having no recording function receives emergency information, the client terminal from missing out on a program viewed. The system can be used in, for example, a system including an apparatus that records and plays broadcast contents and a consumer appliance that plays contents via a network. For example, it can be used as a system including a cable Set Top Box (STB), a digital TV, a DVD/HDD recorder, and so on. Further, it can be also used as a system which includes a mobile appliance such as a mobile phone having a function to play contents via a network.

What is claimed is:

1. A recording and playing system comprising a server terminal and a client terminal connected to each other via a network,
said server terminal including:
a receiving and recording unit configured to, when an instruction to perform recording is received from said client terminal, receive a portion of a broadcast content among a plurality of broadcast contents that are broadcast and record the received 1o portion, the received and recorded portion of the broadcast content being broadcast on a channel which is selected by said client terminal before said client terminal receives emergency information, and the received and recorded portion of the broadcast content being a portion broadcast on the selected channel after the instruction is received; and
a recorded content transmitting unit configured to transmit, in response to a request from said client terminal to perform transmission, the portion of the broadcast content recorded by said receiving and recording unit to said client terminal as a recorded content, and
said client terminal including:
a broadcast content playing unit configured to receive the plurality of broadcast contents, select, from among the received broadcast contents, a broadcast content that is broadcast on a first channel, and play the selected broadcast content;
an emergency information detecting unit configured to receive the emergency information that is broadcast on a second channel and detect start and finish of the reception of the emergency information;
an emergency information notifying unit configured to, while said emergency information detecting unit receives the emergency information, interrupt the playing of the broadcast content on the first channel and notify a user of said client terminal of the received emergency information, the broadcast content on the first channel being selected before said emergency information detecting unit detects that the reception of the emergency information has started;
a recording instructing unit configured to instruct said server terminal to record the broadcast content which is broadcast on the first channel after said emergency information detecting unit detects that the reception of the emergency information has started,, the instruction to said server terminal being issued when said emergency information detecting unit detects that the reception of the emergency information has started; and
a recorded content playing unit configured to receive, from said server terminal, the recorded content which is the portion, recorded by said server terminal, of the broadcast content on the first channel, and to play the recorded content received, instead of the playing performed by said broadcast content playing unit, the recorded content being received from said server terminal by issuing the request to said server terminal for the recorded content, and the reception and playing of the recorded content being performed after said emergency information detecting unit detects that the reception of the emergency information has finished.

2. The recording and playing system according to claim 1,
wherein the emergency information contains information concerning a notification method which is a method for notifying the emergency information,
said client terminal further includes a notification method informing unit configured to identify the notification method contained in the emergency information and to inform said server terminal of the identified notification method, the notification method being a method for notifying the emergency information received by said emergency information detecting unit,
said emergency information notifying unit of said client terminal is configured to, according to the notification method identified by said notification method informing unit, interrupt the playing of the broadcast content on the first channel and notify the user of said client terminal of the received emergency information, the broadcast content on the first channel being selected before said emergency information detecting unit detects that the reception of the emergency information has started, and
said receiving and recording unit of said server terminal is further configured to judge, based on the notification method informed by said notification method informing unit, whether or not the broadcast content on the first channel should be recorded after said emergency information detecting unit of said client terminal detects that the reception of the emergency information has started, and to start recording the broadcast content on the first channel when the instruction to perform the recording is received from said client terminal and a result of the judgment shows that the recording should be performed.

3. The recording and playing system according to claim 1,
wherein said client terminal further includes a server registering unit configured to search for a server terminal which is connected to the network and is capable of receiving and recording a broadcast content, and to register said searched out server terminal as a destination of the instruction to record the broadcast content on the first channel, the playing of which is interrupted,
said recording instructing unit is configured to instruct said server terminal registered by said server registering unit to record the broadcast content on the first channel, the playing of which is interrupted, and
said recorded content playing unit is configured to request said server terminal registered by said server registering unit for the recorded content.

4. The recording and playing system according to claim 3,
wherein said client terminal further includes an alarming unit configured to alarm the user of said client terminal about absence of said server terminal when said server registering unit does not search out said server terminal which is connected to the network and is capable of receiving and recording a broadcast content.

5. The recording and playing system according to claim 3,
wherein said client terminal further includes an alarming unit configured to alarm the user of said client terminal about absence of said server terminal when said server terminal registered by said server registering unit is detected as having disconnected from the network.

6. The recording and playing system according to claim 1,
wherein said client terminal further includes a viewing information transmitting unit configured to transmit viewing information for identifying the broadcast content played by said broadcast content playing unit, and
said receiving and recording unit of said server terminal is configured to identify, from among the plurality of broadcast contents, a broadcast content to be recorded, based on the viewing information transmitted from said viewing information transmitting unit.

7. The recording and playing system according to claim 6,
wherein said viewing information transmitting unit of said client terminal is configured to transmit the viewing information at a predetermined timing, and
said server terminal further includes a terminal-specific viewing information managing unit configured to update terminal-specific viewing information by generating, every time the viewing information is received from said client terminal, terminal-specific viewing information that contains up-to-date viewing information, and to hold the updated terminal-specific viewing information.

8. The recording and playing system according to claim 1,
wherein said server terminal further includes a recording start information transmitting unit configured to transmit, to said client terminal, recording start information indicating that said receiving and recording unit has started the recording, and
said client terminal further includes a recording start displaying unit configured to receive the recording start information and to display, in text, details of the recording start information.

9. The recording and playing system according to claim 1,
wherein said server terminal further includes a recording termination information transmitting unit configured to transmit, to said client terminal, recording termination information indicating that said receiving and recording unit has terminated the recording, and
said client terminal further includes a recording termination displaying unit configured to receive the recording termination information and to display, in text, details of the recording termination information.

10. The recording and playing system according to claim 1,
wherein said recorded content playing unit of said client terminal is configured to request said server terminal for the recorded content when a user operation is received after the reception of the emergency information is detected as having finished, and to start playing the recorded content received through the request.

11. The recording and playing system according to claim 1,
wherein said recorded content playing unit of said client terminal is configured to request said server terminal for the recorded content when the reception of the emergency information is detected as having finished, and to start playing the recorded content received through the request.

12. A recording and playing system comprising a server terminal and a client terminal connected to each other via a network,
said server terminal including:
an emergency information detecting unit configured to receive emergency information that is broadcast on a second channel and detect start and finish of the reception of the emergency information;
a receiving and recording unit configured to receive a portion of a broadcast content among a plurality of broadcast contents that are broadcast, and to record the received portion, the received and recorded portion of the broadcast content being broadcast on a channel which is selected by said client terminal before said emergency information detecting unit detects that the reception of the emergency information has started, and the received and recorded portion of the broadcast content being a portion broadcast on the selected channel after said emergency information detecting unit detects that the reception of the emergency information has started; and
a recorded content transmitting unit configured to transmit the portion of the broadcast content recorded by said receiving and recording unit to said client terminal as a recorded content after said emergency information detecting unit detects that the reception of the emergency information has finished, and
said client terminal including:
a broadcast content playing unit configured to receive the plurality of broadcast contents, select, from among the received broadcast contents, a broadcast content on a first channel, and play the selected broadcast content;
an emergency information receiving unit configured to receive the emergency information that is broadcast on the second channel;
an emergency information notifying unit configured to, while said emergency information receiving unit receives the emergency information, interrupt the playing of the broadcast content on the first channel and notify a user of said client terminal of the received emergency information, the broadcast content on the first channel being selected by said broadcast content playing unit before the reception of the emergency information; and
a recorded content playing unit configured to receive, from said server terminal, the recorded content which is the recorded portion of the broadcast content, and to play the recorded content received, instead of the playing performed by said broadcast content playing unit.

13. The recording and playing system according to claim 12,
wherein the emergency information contains information concerning a notification method which is a method for notifying the emergency information,
said server terminal further includes a notification method identifying unit configured to identify the notification method contained in the emergency information, the notification method being a method for notifying the emergency information received by said emergency information detecting unit, and
said receiving and recording unit of said server terminal is further configured to judge, based on the notification method identified by said notification method identifying unit, whether or not the recording should be performed, and to start the recording when judging that the recording should be performed.

14. The recording and playing system according to claim 12,
said server terminal further including a terminal-specific viewing information managing unit configured to hold terminal-specific viewing information for identifying the broadcast content played by said broadcast content playing unit of said client terminal,
wherein said receiving and recording unit is configured to identify, from among the plurality of broadcast contents, the broadcast content on the first channel which should be recorded, based on the terminal-specific viewing information held by said terminal-specific viewing information managing unit.

15. The recording and playing system according to claim 14,
said client terminal further including a viewing information transmitting unit configured to transmit, at a predetermined timing, viewing information for identifying the broadcast content played by said broadcast content playing unit,
wherein said terminal-specific viewing information managing unit of said server terminal is configured to update the terminal-specific viewing information so that up-to-date viewing information is contained in the terminal-specific viewing information every time the viewing information is received.

16. The recording and playing system according to claim 12,
wherein, upon a user operation, said client terminal requests said server terminal for the recorded content and receives the recorded content from said server terminal, and said recorded content playing unit is configured to start playing the recorded content received.

17. The recording and playing system according to claim 12,
wherein said recorded content transmitting unit of said server terminal is configured to start transmitting the recorded content to said client terminal when said emergency information detecting unit detects that the reception of the emergency information has finished.

18. A client terminal connected to a server terminal via a network, said client terminal comprising:
a broadcast content playing unit configured to receive a plurality of broadcast contents that are broadcast, select, from among the received broadcast contents, a broadcast content which is broadcast on a first channel, and play the selected broadcast content;
an emergency information detecting unit configured to receive emergency information that is broadcast on a second channel and detect start and finish of the reception of the emergency information;
an emergency information notifying unit configured to, while said emergency information detecting unit receives the emergency information, interrupt the playing of the broadcast content on the first channel and notify a user of said client terminal of the received emergency information, the broadcast content on the first channel being selected before said emergency information detecting unit detects that the reception of the emergency broadcast has started;
a recording instructing unit configured to instruct the server terminal to record a portion of the broadcast content which is broadcast on the first channel after said emergency information detecting unit detects that the reception of the emergency information has started, the instruction to the server terminal being issued when said emergency information detecting unit detects that the reception of the emergency information has started; and
a recorded content playing unit configured to receive, from the server terminal, a recorded content which is the portion of the broadcast content on the first channel recorded by the server terminal, and to play the recorded content received, instead of the playing performed by said broadcast content playing unit, the recorded content being received from the server terminal by issuing a request to the server terminal for the recorded content, and the reception and playing of the recorded content being performed after said emergency information detecting unit detects that the reception of the emergency information has finished.

19. A server terminal connected to a client terminal via a network, said server terminal comprising:
an emergency information detecting unit configured to receive emergency information that is broadcast on a second channel and detect start and finish of the reception of the emergency information;
a receiving and recording unit configured to receive a portion of a broadcast content among a plurality of broadcast contents that are broadcast, and to record the received portion, the received and recorded portion of the broadcast content being broadcast on a first channel which is selected by the client terminal before said emergency information detecting unit detects that the reception of the emergency information has started, and the received and recorded portion of the broadcast content being a portion broadcast on the first channel after said emergency information detecting unit detects that the reception of the emergency information has started; and
a recorded content transmitting unit configured to transmit, after said emergency information detecting unit detects that the reception of the emergency information has finished, the portion of the broadcast content recorded by said receiving and recording unit to the client terminal as a recorded content.

20. A method for recording and playing a content in a system including a server terminal and a client terminal connected to each other via a network, said method comprising,
in the client terminal:
receiving a plurality of broadcast contents that are broadcast, selecting, from among the plurality of broadcast contents received, a broadcast content which is broadcast on a first channel, and playing the selected broadcast content;
receiving emergency information which is broadcast on a second channel; and
while the emergency information is received, interrupting the playing of the broadcast content on the first channel and notifying a user of the client terminal of the received emergency information, and
in the server terminal:
receiving a portion of the broadcast content on the first channel among the plurality of broadcast contents that are broadcast, and recording the received portion, the received and recorded portion of the broadcast content being a portion broadcast on the first channel after the reception of the emergency information starts in the client terminal; and
transmitting the recorded portion of the broadcast content to the client terminal as a recorded content, after the reception of the emergency information finishes in the client terminal,
wherein said method further comprises, in the client terminal, receiving the recorded content from the server terminal and playing the recorded content received, instead of the playing of the broadcast content being broadcast.

21. The method for recording and playing a content according to claim 20,
wherein, in the server terminal:
when an instruction to perform recording is received from the client terminal, a portion of a broadcast content among the plurality of broadcast contents is received and the received portion is recorded, the received and recorded portion of the broadcast content being broadcast on a channel selected in the client terminal before the emergency information is received in the client terminal, and the received and recorded portion of the broadcast content being a portion broadcast on the selected channel after the instruction is received; and
in response to a request from the client terminal to perform transmission, the recorded content which is the recorded portion of the broadcast content is transmitted to the client terminal, and
in the client terminal:
start and finish of the reception of the emergency information which is broadcast on the second channel are detected;
when it is detected that the reception of the emergency information has started, an instruction is issued to the server terminal to record the portion of the broadcast content which is broadcast on the first channel after it is detected that the reception of the emergency information has started; and
after it is detected that the reception of the emergency information has finished, the recorded content which is the recorded portion of the broadcast content is received from the server terminal through the request to the server terminal for the recorded content.

22. The method for recording and playing a content according to claim 20,
wherein in the server terminal:
the emergency information on the second channel is received and start and finish of the reception of the emergency information are detected;
a portion of the broadcast content on the first channel, selected in the client terminal among the plurality of broadcast contents, is received, and the received portion is recorded, the broadcast content on the first channel being selected before it is detected that the reception of the emergency information has started, and the received and recorded portion of the broadcast content being a portion broadcast on the first channel after it is detected that the reception of the emergency information has started; and
the recorded content which is the recorded portion of the broadcast content is transmitted to the client terminal after it is detected that the reception of the emergency information has finished.

23. A method for a client terminal to play a content, the client terminal being connected to a server terminal via a network, said method comprising:
receiving a plurality of broadcast contents that are broadcast, selecting, from among the plurality of broadcast contents received, a broadcast content that is broadcast on a first channel, and playing the selected broadcast content;
receiving emergency information that is broadcast on a second channel and detecting start and finish of the reception of the emergency information;
while the emergency information is received, interrupting the playing of the broadcast content on the first channel and notifying a user of the client terminal of the received emergency information, the broadcast content on the first channel being selected before it is detected that the reception of the emergency information has started;
instructing, when it is detected that the reception of the emergency information has started, the server terminal to record a portion of the broadcast content which is broadcast on the first channel after it is detected that the reception of the emergency information has started; and
after it is detected that the reception of the emergency information has finished, receiving from the server terminal a recorded content which is the portion of the broadcast content on the first channel recorded in the server terminal, through a request to the server terminal for the recorded content, and playing the recorded content received, instead of the playing of the broadcast content being broadcast.

24. A method for a server terminal to record a content, the server terminal being connected to a client terminal via a network, said method comprising:
receiving emergency information that is broadcast on a second channel and detecting start and finish of the reception of the emergency information;
receiving a portion of a broadcast content which is broadcast on a first channel selected in the client terminal among a plurality of broadcast contents that are broadcast, and recording the received portion, the broadcast content on the first channel being selected before it is detected that the reception of the emergency information has started, and the received and recorded portion of the broadcast content being a portion broadcast on the first channel after it is detected that the reception of the emergency information has started; and
transmitting to the client terminal the recorded portion of the broadcast content as a recorded content, after it is detected that the reception of the emergency information has finished.

25. A computer program, recorded on a computer-readable recording medium, for a client terminal to play a content, the client terminal being connected to a server terminal via a network, said program causing a computer of the client terminal to execute:
receiving a plurality of broadcast contents that are broadcast, selecting, from among the plurality of broadcast contents received, a broadcast content which is broadcast on a first channel, and playing the selected broadcast content;
receiving emergency information which is broadcast on a second channel and detecting start and finish of the reception of the emergency information;
while the emergency information is received, interrupting the playing of the broadcast content on the first channel and notifying a user of the client terminal of the received emergency information, the broadcast content on the first channel being selected before it is detected that the reception of the emergency information has started;
instructing, when it is detected that the reception of the emergency information has started, the server terminal to record a portion of the broadcast content which is broadcast on the first channel after it is detected that the reception of the emergency information has started; and
after it is detected that the reception of the emergency information has finished, receiving from the server terminal a recorded content which is the portion of the broadcast content on the first channel recorded in the server terminal, through a request to the server terminal for the recorded content, and playing the recorded content received, instead of the playing of the broadcast content being broadcast.

26. A computer program, recorded on a computer-readable recording medium, for a server terminal to record a content, the server terminal being connected to a client terminal via a network, said program causing a computer of the server terminal to execute:
receiving emergency information which is broadcast on a second channel and detecting start and finish of the reception of the emergency information;
receiving a portion of a broadcast content on a first channel selected in the client terminal from among a plurality of broadcast contents that are broadcast, and recording the received portion, the broadcast content on the first channel being selected before it is detected that the reception of the emergency information has started, and the received and recorded portion of the broadcast content being a portion broadcast on the first channel after it is detected that the reception of the emergency information has started; and
transmitting the recorded portion of the broadcast content to the client terminal as a recorded content, after it is detected that the reception of the emergency information has finished.
